(19) United States
(12) Patent Application Publication
(10) Pub. No.: US 2017/0311204 A1
(43) Pub. Date: Oct. 26, 2017

(54) ACCESS POINT (AP), STATION (STA) AND METHOD FOR LINK AGGREGATION

(71) Applicants: Laurent Cariou, Portland, OR (US); Robert J. Stacey, Portland, OR (US); Po-Kai Huang, West Lafayette, IN (US); Bahareh Sadeghi, Portland, OR (US); Carlos Cordeiro, Portland, OR (US)

(72) Inventors: Laurent Cariou, Portland, OR (US); Robert J. Stacey, Portland, OR (US); Po-Kai Huang, West Lafayette, IN (US); Bahareh Sadeghi, Portland, OR (US); Carlos Cordeiro, Portland, OR (US)

(21) Appl. No.: 15/375,377

(22) Filed: Dec. 12, 2016

Related U.S. Application Data
(60) Provisional application No. 62/327,593, filed on Apr. 26, 2016.
(60) Provisional application No. 62/327,612, filed on Apr. 26, 2016.

(51) Int. Cl. H04W 28/08; H04L 12/709; H04W 74/08; H04W 84/12

(52) U.S. Cl. CPC H04W 28/085; H04W 74/08; H04L 45/245; H04W 84/12

(57) ABSTRACT

Embodiments of an access point (AP), station (STA) and method for link aggregation are generally described herein. An aggregated link for multiple channels may be established. The link may be aggregated at an upper medium access control (MAC) entity, which may communicate with multiple lower MAC entities for the channels. The upper MAC entity may assign packet numbers (PNs) to a sequence of MAC service data units (MSDUs) for the aggregated link and may allocate the MSDUs to the channels. The PNs may enable reordering at a receiving entity. The lower MAC entities may assign sequence numbers (SNs) to MAC protocol data units (MPDUs). The SNs may enable acknowledgement at a receiving entity. The MPDUs may include the SNs and the corresponding PNs.

### PRIORITY CLAIM

This application claims priority under 35 USC 119(e) to U.S. Provisional Patent Application Ser. No. 62/327,612, filed Apr. 26, 2016 [reference number P98428Z (9884.014PRV)] and to U.S. Provisional Patent Application Ser. No. 62/327,593, filed Apr. 26, 2016 [reference number P98426Z (9884.016PRV)], both of which are incorporated herein by reference in their entirety.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11ac standard or the IEEE 802.11ax study group (SG) (named DensiFi). Some embodiments relate to high-efficiency (HE) wireless or high-efficiency WLAN or Wi-Fi communications. Some embodiments relate to link aggregation, including link aggregation of links and/or channels in different frequency bands.

### BACKGROUND

Wireless communications have been evolving toward ever increasing data rates (e.g., from IEEE 802.11a/g to IEEE 802.11n to IEEE 802.11ac). In high-density deployment situations, overall system efficiency may become more important than higher data rates. For example, in high-density hotspot and cellular offloading scenarios, many devices competing for the wireless medium may have low to moderate data rate requirements (with respect to the very high data rates of IEEE 802.11ac). A recently-formed study group for Wi-Fi evolution referred to as the IEEE 802.11 High Efficiency WLAN (HEW) study group (SG) (i.e., IEEE 802.11ax) is addressing these high-density deployment scenarios.

### BRIEF DESCRIPTION OF THE DRAWINGS

FIG. 1 illustrates a wireless network in accordance with some embodiments;

FIG. 2 illustrates an example machine in accordance with some embodiments;

FIG. 3 illustrates a station (STA) in accordance with some embodiments and an access point (AP) in accordance with some embodiments;

FIG. 4 illustrates the operation of a method of communication in accordance with some embodiments;

FIG. 5 illustrates example scenarios of link aggregation in accordance with some embodiments;

FIG. 6 illustrates another example scenario of link aggregation in accordance with some embodiments;

FIG. 7 illustrates another example scenario of link aggregation in accordance with some embodiments;

FIG. 8 illustrates another example scenario of link aggregation in accordance with some embodiments;

FIG. 9 illustrates another example scenario of link aggregation in accordance with some embodiments;

FIG. 10 illustrates an example medium access control (MAC) protocol data units (MPDU) in accordance with some embodiments;

FIG. 11 illustrates another example scenario of link aggregation in accordance with some embodiments;

FIG. 12 illustrates another example MPDU in accordance with some embodiments;

FIG. 13 illustrates another example scenario of link aggregation in accordance with some embodiments;

FIG. 14 illustrates the operation of another method of link aggregation in accordance with some embodiments;

FIG. 15 is a block diagram of a radio architecture in accordance with some embodiments;

FIG. 16 illustrates a front-end module circuitry for use in the radio architecture of FIG. 15 in accordance with some embodiments;

FIG. 17 illustrates a radio IC circuitry for use in the radio architecture of FIG. 15 in accordance with some embodiments; and

FIG. 18 illustrates a baseband processing circuitry for use in the radio architecture of FIG. 15 in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

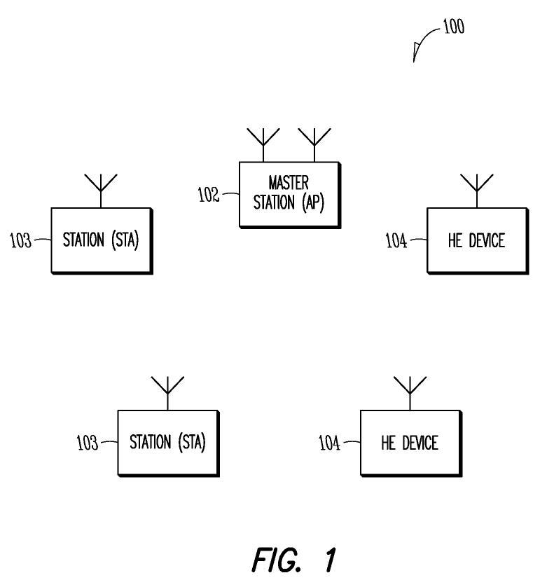

FIG. 1 illustrates a wireless network in accordance with some embodiments. In some embodiments, the network 100 may be a High Efficiency (HE) Wireless Local Area Network (WLAN) network. In some embodiments, the network 100 may be a WLAN or a Wi-Fi network. These embodiments are not limiting, however, as some embodiments of the network 100 may include a combination of such networks. That is, the network 100 may support HE devices in some cases, non HE devices in some cases, and a combination of HE devices and non HE devices in some cases. Accordingly, it is understood that although techniques described herein may refer to either a non HE device or to an HE device, such techniques may be applicable to both non HE devices and HE devices in some cases.

Referring to FIG. 1, the network 100 may include any or all of the components shown, and embodiments are not limited to the number of each component shown in FIG. 1. In some embodiments, the network 100 may include a master station (AP) 102 and may include any number (including zero) of stations (STAs) 103 and/or HE devices 104. In some embodiments, the AP 102 may transmit signals, data packets and/or frames to the STA 103. These embodiments will be described in more detail below.

The AP 102 may be arranged to communicate with one or more of the components shown in FIG. 1 in accordance with one or more IEEE 802.11 standards (including 802.11ax and/or others), other standards and/or other communication protocols. It should be noted that embodiments are not limited to usage of an AP 102. References herein to the AP 102 are not limiting and references herein to the master station 102 are also not limiting. In some embodiments, a STA 103, HE device 104 and/or other device may be configurable to operate as a master station. Accordingly, in such embodiments, operations that may be performed by the AP 102 as described herein may be performed by the STA 103, HE device 104 and/or other device that is configurable to operate as the master station.

In some embodiments, one or more of the STAs 103 may be legacy stations. These embodiments are not limiting, however, as the STAs 103 may be configured to operate as HE devices 104 or may support HE operation in some embodiments. The master station 102 may be arranged to communicate with the STAs 103 and/or the HE stations 104 in accordance with one or more of the IEEE 802.11 standards, including 802.11ax and/or others. In accordance with some HE embodiments, an access point (AP) may operate as the master station 102 and may be arranged to contend for a wireless medium (e.g., during a contention period) to receive exclusive control of the medium for an HE control period (i.e., a transmission opportunity (TXOP)). The master station 102 may, for example, transmit a master-sync or control transmission at the beginning of the HE control period to indicate, among other things, which HE stations 104 are scheduled for communication during the HE control period. During the HE control period, the scheduled HE stations 104 may communicate with the master station 102 in accordance with a non-contention based multiple access technique. This is unlike conventional Wi-Fi communications in which devices communicate in accordance with a contention-based communication technique, rather than a non-contention based multiple access technique. During the HE control period, the master station 102 may communicate with HE stations 104 using one or more HE PPDUs. During the HE control period, STAs 103 not operating as HE devices may refrain from communicating in some cases. In some embodiments, the master-sync transmission may be referred to as a control and schedule transmission.

In some embodiments, the multiple-access technique used during the HE control period may be a scheduled orthogonal frequency-division multiple access (OFDMA) technique, although this is not a requirement. In some embodiments, the multiple access technique may be a time-division multiple access (TDMA) technique or a frequency-division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HE control period may be configured for uplink or downlink data communications.

The master station 102 may also communicate with STAs 103 and/or other legacy stations in accordance with legacy IEEE 802.11 communication techniques. In some embodiments, the master station 102 may also be configurable to communicate with the HE stations 104 outside the HE control period in accordance with legacy IEEE 802.11 communication techniques, although this is not a requirement.

In some embodiments, the HE communications during the control period may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, sub-channel bandwidths less than 20 MHz may also be used. In these embodiments, each channel or sub-channel of an HE communication may be configured for transmitting a number of spatial streams.

In some embodiments, high-efficiency (HE) wireless techniques may be used, although the scope of embodiments is not limited in this respect. As an example, techniques included in 802.11ax standards and/or other standards may be used. In accordance with some embodiments, a master station 102 and/or HE stations 104 may generate an HE packet in accordance with a short preamble format or a long preamble format. The HE packet may comprise a legacy signal field (L-SIG) followed by one or more HE signal fields (HE-SIG) and an HE long-training field (HE-LTF). For the short preamble format, the fields may be configured for shorter-delay spread channels. For the long preamble format, the fields may be configured for longer-delay spread channels. These embodiments are described in more detail below. It should be noted that the terms “HEW” and “HE” may be used interchangeably and both terms may refer to high-efficiency Wireless Local Area Network operation and/or high-efficiency Wi-Fi operation.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

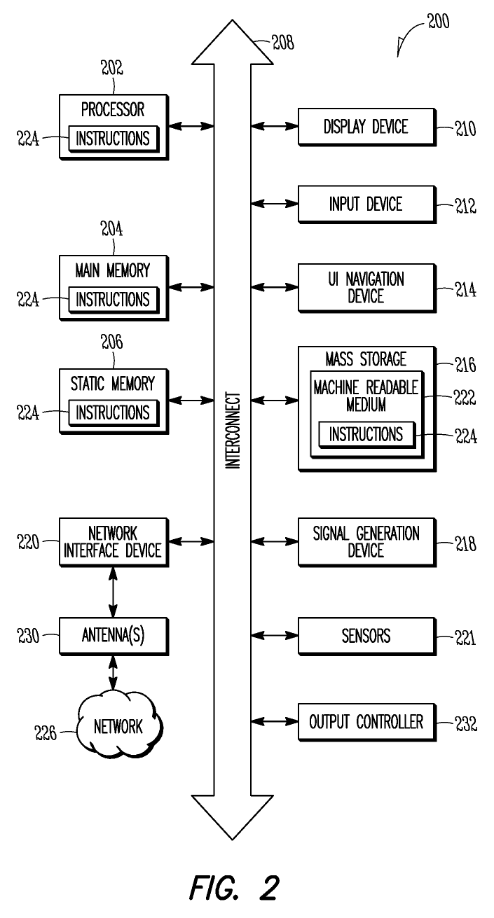

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be an AP 102, STA 103, HE device, HE AP, HE STA, UE, eNB, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB)), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium. In some embodiments, the machine readable medium may be or may include a computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone Service (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

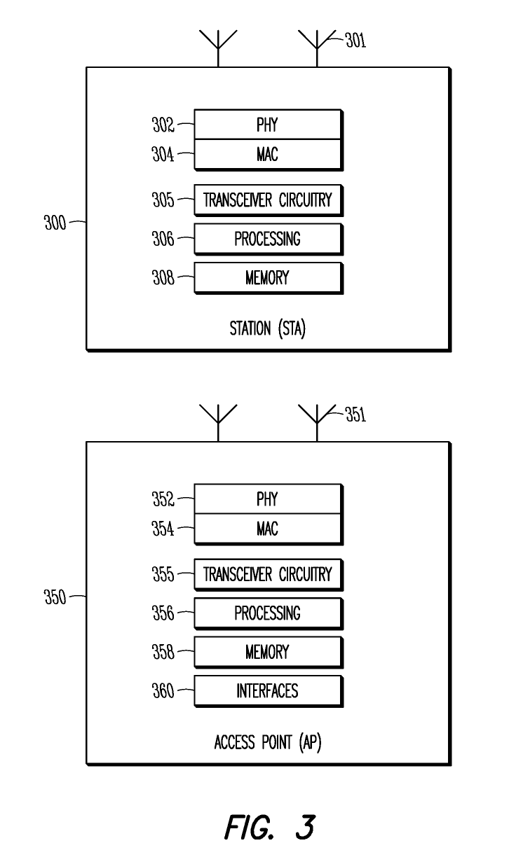

FIG. 3 illustrates a station (STA) in accordance with some embodiments and an access point (AP) in accordance with some embodiments. It should be noted that in some embodiments, an STA or other mobile device may include some or all of the components shown in either FIG. 2 or FIG. 3 (as in 300) or both. The STA 300 may be suitable for use as an STA 103 as depicted in FIG. 1, in some embodiments. It should also be noted that in some embodiments, an AP or other base station may include some or all of the components shown in either FIG. 2 or FIG. 3 (as in 350) or both. The AP 350 may be suitable for use as an AP 102 as depicted in FIG. 1, in some embodiments.

The STA 300 may include physical layer circuitry 302 and a transceiver 305, one or both of which may enable transmission and reception of signals to and from components such as the AP 102 (FIG. 1), other STAs or other devices using one or more antennas 301. As an example, the physical layer circuitry 302 may perform various encoding and decoding functions that may include formation of baseband signals for transmission and decoding of received signals. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers. The STA 300 may also include medium access control (MAC) layer circuitry 304 for controlling access to the wireless medium. The STA 300 may also include processing circuitry 306 and memory 308 arranged to perform the operations described herein.

The AP 350 may include physical layer circuitry 352 and a transceiver 355, one or both of which may enable transmission and reception of signals to and from components such as the STA 103 (FIG. 1), other APs or other devices using one or more antennas 351. As an example, the physical layer circuitry 352 may perform various encoding and decoding functions that may include formation of baseband signals for transmission and decoding of received signals. As another example, the transceiver 355 may perform various transmission and reception functions such as conversion of signals between a baseband range and a Radio Frequency (RF) range. Accordingly, the physical layer circuitry 352 and the transceiver 355 may be separate components or may be part of a combined component. In addition, some of the described functionality related to transmission and reception of signals may be performed by a combination that may include one, any or all of the physical layer circuitry 352, the transceiver 355, and other components or layers. The AP 350 may also include medium access control (MAC) layer circuitry 354 for controlling access to the wireless medium. The AP 350 may also include processing circuitry 356 and memory 358 arranged to perform the operations described herein.

The antennas 301, 351, 230 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 301, 351, 230 may be effectively separated to take advantage of spatial diversity and the different channel characteristics that may result.

In some embodiments, the STA 300 may be configured as an HE device 104 (FIG. 1), and may communicate using OFDM and/or OFDMA communication signals over a multicarrier communication channel. In some embodiments, the AP 350 may be configured to communicate using OFDM and/or OFDMA communication signals over a multicarrier communication channel. In some embodiments, the HE device 104 may be configured to communicate using OFDM communication signals over a multicarrier communication channel. Accordingly, in some cases, the STA 300, AP 350 and/or HE device 104 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HE standards, although the scope of the embodiments is not limited in this respect as they may also be suitable to transmit and/or receive communications in accordance with other techniques and standards. In some other embodiments, the AP 350, HE device 104 and/or the STA 300 configured as an HE device 104 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect. Embodiments disclosed herein provide two preamble formats for High Efficiency (HE) Wireless LAN standards specification that is under development in the IEEE Task Group 11ax (TGax).

In some embodiments, the STA 300 and/or AP 350 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 300 and/or AP 350 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 300 and/or AP 350 may include one or more of a keyboard, a display, a non-volatile memory port, multiple antennas, a graphics processor, an application processor, speakers, and other mobile device elements. The display may be an LCD screen including a touch screen.

Although the STA 300 and the AP 350 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

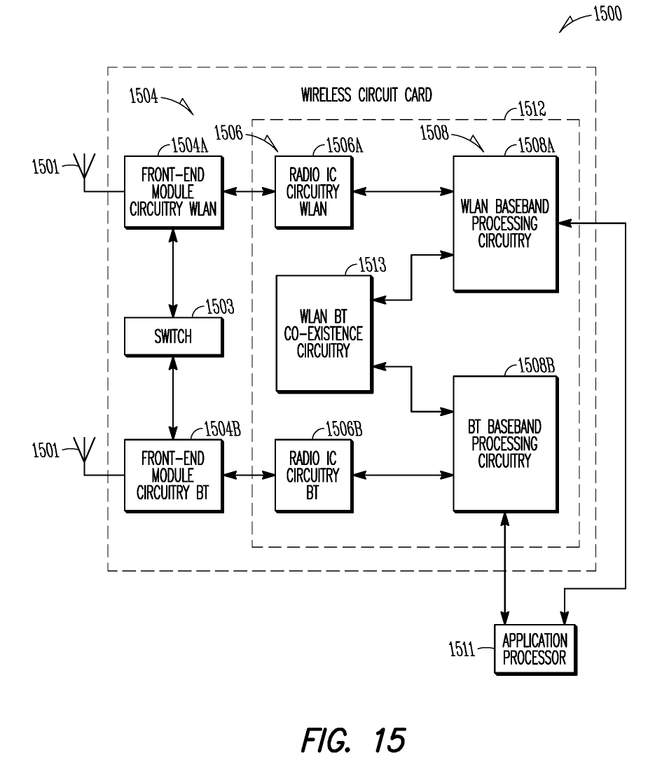

It should be noted that in some embodiments, an apparatus used by an STA may include various components of the STA 300 as shown in FIG. 3 and/or the example machine 200 as shown in FIG. 2 and/or one or more components from any of FIGS. 15-18. Accordingly, techniques and operations described herein that refer to the STA 300 (or 103) may be applicable to an apparatus for an STA, in some embodiments. It should also be noted that in some embodiments, an apparatus used by an AP may include various components of the AP 350 as shown in FIG. 3 and/or the example machine 200 as shown in FIG. 2 and/or one or more components from any of FIGS. 15-18. Accordingly, techniques and operations described herein that refer to the AP 350 (or 102) may be applicable to an apparatus for an AP, in some embodiments. In addition, an apparatus for a mobile device and/or base station may include one or more components shown in FIGS. 2-3, in some embodiments. Accordingly, techniques and operations described herein that refer to a mobile device and/or base station may be applicable to an apparatus for a mobile device and/or base station, in some embodiments.

In accordance with some embodiments, the AP 102 may establish an aggregated link for multiple channels. The link may be aggregated at an upper medium access control (MAC) entity, which may communicate with multiple lower MAC entities for the channels. The upper MAC entity may assign packet numbers (PNs) to a sequence of MAC service data units (MSDUs) for the aggregated link and may allocate the MSDUs to the channels. The PNs may enable reordering at a receiving entity. The lower MAC entities may assign sequence numbers (SNs) to MAC protocol data units (MPDUs). The SNs may enable acknowledgement at a receiving entity. The MPDUs may include the SNs and the corresponding PNs. These embodiments will be described in more detail below.

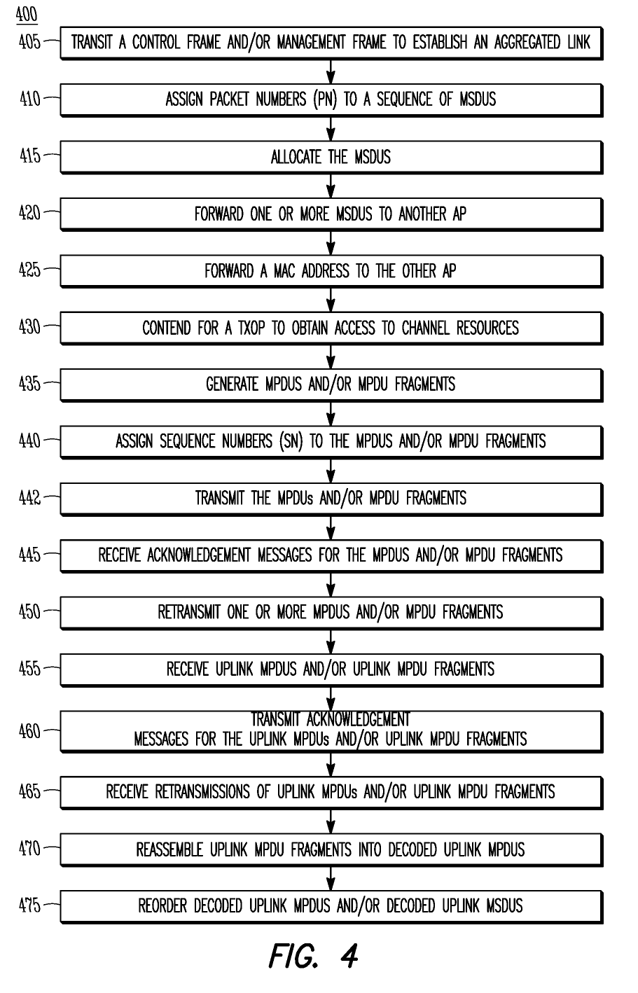

FIG. 4 illustrates the operation of a method of communication in accordance with some embodiments. It is important to note that embodiments of the method 400 may include additional or even fewer operations or processes in comparison to what is illustrated in FIG. 4. In addition, embodiments of the method 400 are not necessarily limited to the chronological order that is shown in FIG. 4. In describing the method 400, reference may be made to FIGS. 1-3 and 5-14, although it is understood that the method 400 may be practiced with any other suitable systems, interfaces and components.

In some embodiments, the AP 102 and/or STA 103 may be configurable to operate as an HE device 104. Although reference may be made to an AP 102 and/or STA 103 herein, including as part of the descriptions of the method 400 and/or other methods described herein, it is understood that an HE device 104, an AP 102 configurable to operate as an HE device 104 and/or STA 103 configurable to operate as an HE device 104 may be used in some embodiments. In addition, the method 400 and other methods described herein may be applicable to STAs 103, HE devices 104 and/or APs 102 operating in accordance with one or more standards and/or protocols, such as 802.11, Wi-Fi, wireless local area network (WLAN) and/or other, but embodiments of those methods are not limited to just those devices. In some embodiments, the method 400 and other methods described herein may be practiced by other mobile devices, such as an Evolved Node-B (eNB) or User Equipment (UE). The method 400 and other methods described herein may also be practiced by wireless devices configured to operate in other suitable types of wireless communication systems, including systems configured to operate according to various Third Generation Partnership Project (3GPP) Long Term Evolution (LTE) standards. The method 400 may also be applicable to an apparatus for an STA 103, HE device 104 and/or AP 102 or other device described above, in some embodiments.

It should also be noted that embodiments are not limited by references herein (such as in descriptions of the methods 400, 1400 and/or other descriptions herein) to transmission, reception and/or exchanging of elements such as frames, messages, requests, indicators, signals or other elements. In some embodiments, such an element may be generated, encoded or otherwise processed by processing circuitry (such as by a baseband processor included in the processing circuitry) for transmission. The transmission may be performed by a transceiver or other component, in some cases. In some embodiments, such an element may be decoded, detected or otherwise processed by the processing circuitry (such as by the baseband processor). The element may be received by a transceiver or other component, in some cases. In some embodiments, the processing circuitry and the transceiver may be included in a same apparatus. The scope of embodiments is not limited in this respect, however, as the transceiver may be separate from the apparatus that comprises the processing circuitry, in some embodiments.

At operation 405, the AP 102 may transmit one or more control frames to establish an aggregated link for a first channel and a second channel. In some embodiments, the aggregated link may comprise multiple links, including but not limited to a wireless link. For instance, communication over a first link of the aggregated link may be performed in the first channel and communication over a second link of the aggregated link may be performed in the second channel. Accordingly, although some techniques, concepts, operations and/or methods may be described herein in terms of channels of an aggregated link, it is understood that some of those techniques, concepts, operations and/or methods may be applicable to links of the aggregated link.

The control frame(s) may be transmitted as part of a procedure (such as a set of operations and/or frames exchanged) for the establishment of the aggregated link, in some cases. It should be noted that other frame(s) may be transmitted by the AP 102 for the establishment of the aggregated link, in some embodiments, in addition to or instead of the control frame(s). For instance, one or more management frames may be transmitted. In some embodiments, the AP 102 may also receive one or more frames (control, management and/or other) as part of the establishment of the aggregated link. For instance, the AP 102 may intend to communicate with a STA 103 on the aggregated link, and may receive one or more frames from the STA 103.

In some embodiments, the aggregated link may be aggregated at an upper medium access control (MAC) entity. The upper MAC entity may perform (and/or may be configured to perform) one or more operations related to the aggregated link, including but not limited to transmission of control information to one or more lower MAC entities, management operations for the aggregated link, control operations for the aggregated link and/or other operations. For instance, the upper MAC entity may be configured to communicate control information for the aggregated link to a first lower MAC entity for the first channel and to a second lower MAC entity for the second channel. It should be noted that an aggregated link with two channels (the first and second channels) may be described herein, but embodiments are not limited to two channels. Some or all of the techniques, concepts, operations and/or methods described herein may be applicable to aggregated links with more than two channels.

In some embodiments, the processing circuitry of the AP 102 may implement the upper MAC entity. In some embodiments, the upper MAC entity may be implemented in the AP 102. In some embodiments, the upper MAC entity may be implemented in an apparatus for the AP 102. In some embodiments, the upper MAC entity may be supported at the AP 102, in some cases. The upper MAC entity may be configured to communicate with one or more lower MAC entities. In a non-limiting example, a lower MAC entity may be used for each link of the aggregated link. Accordingly, a lower MAC entity may be used for communication on each channel.

Various configurations of the aggregated link are possible. In some embodiments, the processing circuitry of the AP 102 may implement one or more lower MAC entities. In some embodiments, one or more lower MAC entities may be implemented in the AP 102 (and/or apparatus for the AP 102) and one or more lower MAC entities may be implemented external to the AP 102 (such as in another AP 102 and/or other device). Such devices externa to the AP 102 may be collocated with the AP 102 in some cases, and may be non-collocated with the AP 102 in some cases. In a non-limiting example, the lower MAC entities may be implemented in the AP 102 or in another AP 102, and the other AP 102 may be collocated or non-collocated with the AP 102.

In another non-limiting example, one or more configurations of the aggregated link may be used. Accordingly, the AP 102 and/or STA 103 may be configured to support communication in accordance with one or more configurations of the aggregated link. In a first example configuration of the aggregated link, the first and second channels may be configured for communication of data from the AP 102 to a STA 103, and the second lower MAC entity may be implemented in the AP 102 (and/or apparatus of the AP 102). In a second configuration of the aggregated link, the first channel may be configured for communication of first data from the AP 102 to the STA 103 and the second channel may be configured for communication of second data from another AP 102 to the STA 103. The second data may be forwarded from the AP 102 to the other AP 102, and the second lower MAC may be external to the AP 102.

In some embodiments, the aggregated link may be configurable for a particular configuration wherein the first channel is configured for usage by the AP 102 for communication with a STA 103 in a first frequency band, and the second channel is configured for usage by another AP 102 for communication with the STA 103 in a second frequency band. The communication on the first channel may be performed cooperatively and/or under control of a first lower MAC, which may be implemented in the AP 102 (and/or apparatus for the AP 102) in this case. The communication on the second channel may be performed cooperatively and/or under control of a second lower MAC, which may be external to the AP 102 (such as in the other AP 102) in this case.

In another non-limiting example, an aggregated link may comprise a plurality of channels, in which a first portion of the channels may be supported by the AP 102 and a second portion of the channels are supported by another AP 102. In some embodiments, the aggregated link may be configurable for a particular configuration in which the first portion of the channels are in a first frequency band, and the second portion of the channels are in a second frequency band.

In some embodiments, the aggregated link may be configurable for channels in a same frequency band. In some embodiments, the aggregated link may be configurable for channels in multiple frequency bands. In some embodiments, the aggregated link may comprise a plurality of links between the AP 102 and the STA 103, and the aggregated link may be configurable for links supported in a same frequency band or for links supported in different frequency bands.

In some embodiments, one or more frequency ranges (such as cellular, microwave and/or other) may be used. For instance, one or more channels may be in a first frequency band in a cellular range and one or more channels may be in a second frequency band in a microwave range. This example is not limiting, however, as any suitable frequency band(s) may be used, including frequency band(s) that may or may not be in a same frequency range, frequency category or other.

In a non-limiting example, multiple protocols (physical layer or other) may be used for one or more of the different channels. In another non-limiting example, a same protocol may be used on the channels. Such protocols may include a wireless local area network (WLAN) protocol, 3GPP protocol and/or other suitable protocol. These examples are not limiting, however.

In some embodiments, bandwidths of the different channels (primary and secondary channels) may be of a same bandwidth. In some embodiments, one or more channels may be configurable for different bandwidths.

In some embodiments, the aggregated link may be configurable for channels in licensed spectrum, unlicensed spectrum or a combination thereof. Any of the primary channel and/or secondary channels may be in licensed or unlicensed spectrum.

At operation 410, the AP 102 may assign packet numbers (PNs) to a sequence of MAC service data units (MSDUs) for the aggregated link. In some embodiments, the assignment of the PNs may be performed at the upper MAC entity, although the scope of embodiments is not limited in this respect.

In some embodiments, the PNs may be assigned to enable reordering of decoded MSDUs at a receiving entity. For instance, the AP 102 may assign PNs to MSDUs and a receiving STA 103 may use the PNs to reorder MSDUs. The STA 103 may send a reordered sequence of MSDUs to a higher layer of the STA 103, in some embodiments.

In some embodiments, the PNs assigned to consecutive MSDUs may be spaced apart by a predetermined PN spacing. In some cases, the PN spacing may be configurable to a value greater than or equal to one. In some cases, the PN spacing may be predetermined.

In a non-limiting example, the PN spacing may be based at least partly on a maximum number of MPDU fragments into which MPDUs are to be fragmented. For instance, the maximum number of MPDU fragments may be included in a standard (such as W-LAN, 802.11 and/or other), although embodiments are not limited to values included in a standard. In some cases, the PNs may be assigned to the MSDUs and MPDUs may be generated based on the MSDUs. In addition, fragmentation may be used in some cases, in which a number of MPDU fragments may be generated based on a particular MSDU. Accordingly, if the PNs of consecutive MSDUs are incremented by a spacing equal to the maximum number of fragments, the MPDU fragments may be assigned PNs (at the lower MAC layer, for instance) in a potentially non-ambiguous manner. For instance, the value of PN1 may be assigned to a first MSDU and PN2 may be assigned to a second, subsequent MSDU. If a difference between PN1 and PN2 is at least Nmax (in which Nmax is the maximum number of fragments) and Nfrag fragments are to be used, the MPDU fragments (if fragmentation is performed) may be assigned values in a range of PN1, PN1+1, PN1+Nfrag−1. The PNs of the MPDU and/or MPDU fragments for the second MSDU would begin at PN1+Nfrag due to the spacing of Nfrag. Hence the range given above for potential fragments of the first MSDU would be less than PN1+Nfrag, and the numbering may be non-ambiguous.

In another non-limiting example, a sequence of MPDU fragments based on an MSDU may be generated, wherein a number of MPDU fragments in the sequence is less than or equal to the maximum number of MPDU fragments, wherein consecutive MPDU fragments of the sequence include consecutive PNs, wherein a starting MPDU fragment of the sequence includes the PN of the second MSDU, and wherein the MPDU fragments further include SNs based at least partly on the chronological order of transmission on the particular link.

In another non-limiting example, the PN spacing may be based at least partly on a maximum number of control frames or management frames that may be sent by the AP 102 between consecutive MSDUs. For instance, the maximum number of control frames and/or management frames may be included in a standard (such as W-LAN, 802.11 and/or other), although embodiments are not limited to values included in a standard. When one or more control frames and/or management frames are to be sent after the MPDU and/or MPDU fragments of the first MSDU (assigned PN1, for instance) and before the MPDU and/or MPDU fragments of the second MSDU (assigned PN2, for instance), a value between PN1 and PN2 may be assigned to the control/management frame(s). It should be noted that whether control/management frame(s) are to be sent may be determined by the lower MAC entity, which may not be in the same AP 102 as the upper MAC entity, in some cases.

In another non-limiting example, a control frame or management frame may be transmitted between a first MPDU and a second MPDU. The first MPDU may be based on a first MSDU that is assigned a first PN. The second MPDU may be based on a second MSDU that is assigned a second PN. The control frame or management frame may include a PN that is between the first and second PNs. This example may be extended to multiple control/management frames.

In another non-limiting example, a PN spacing between consecutive MSDUs may be based on a combination of the maximum number of fragments and the maximum number of control/management frame(s). Accordingly, in a worst case in which the first MSDU is used to generate the maximum number of MPDU fragments and the maximum number of control/management frame(s) is sent between the first and second MSDUs, the MPDU fragments and the control/management frame(s) may be numbered starting with the value of PN1 and ending with a value less than PN2.

In some embodiments, the PN spacing may be based on one or more other factors in addition to or instead of the maximum number of fragments and the maximum number of control/management frame(s).

At operation 415, the MSDUs may be allocated to the channels. For instance, in a scenario in which two channels are used, one or more of the MSDUs may be allocated to the first channel and one or more of the MSDUs may be allocated to the second channel. This example may be extended to more than two channels. In addition, the MSDUs may be allocated to the links of the aggregated link, in some embodiments.

In a non-limiting example, the MSDUs may be allocated in accordance with a load balance of data traffic on the channels. The scope of embodiments is not limited in this respect, however, as other techniques for distribution of the MSDUs to the channels may be used. In some embodiments, the allocation may be performed by the upper MAC entity, although the scope of embodiments is not limited in this respect.

At operation 420, the AP 102 may forward one or more MSDUs to one or more other APs 102. In some embodiments, one or more channels may be supported by other AP(s) 102. In some cases, the other AP(s) may support corresponding lower MAC entities for those channels. The MSDUs allocated to the other AP(s) 102 may be forwarded to the other AP(s) 102 by the AP 102. In some embodiments, the upper MAC entity may forward the MSDUs, although the scope of embodiments is not limited in this respect. In a non-limiting example, the AP 102 may forward one or more MSDUs to a second lower MAC entity that is external to the AP 102. The AP 102 may also forward the PNs assigned to the MSDUs.

In some embodiments, the upper MAC entity (supported by the AP 102) may forward MSDUs to one or more lower MAC entities that are also supported by the AP 102.

At operation 425, the AP 102 may forward a MAC address to one or more other APs 102. The MAC address may be forwarded for inclusion in MPDUs and/or MPDU fragments, although the scope of embodiments is not limited in this respect. In some embodiments, the MAC address may be used for the MSDUs of the sequence regardless of the channel/link/AP/lower MAC entity to which the MSDUs are assigned. In some embodiments, one or more channels may be supported by other AP(s) 102. In some cases, the other AP(s) may support corresponding lower MAC entities for those channels. The MAC address may be forwarded to the other AP(s) 102 by the AP 102. In some embodiments, the upper MAC entity may forward the MAC address, although the scope of embodiments is not limited in this respect. In a non-limiting example, the AP 102 may forward the MAC address to a second lower MAC entity that is external to the AP 102. The AP 102 may also forward the PNs assigned to the MSDUs. In some embodiments, the upper MAC entity (supported by the AP 102) may forward the MAC address to one or more lower MAC entities that are also supported by the AP 102. It should be noted that embodiments are not limited to usage of the MAC address, as other identifiers may also be used, in some embodiments.

At operation 430, the AP 102 may contend for a transmission opportunity (TXOP) to obtain access to a channel. In some embodiments, separate contention may be performed for each channel of the aggregated link, although the scope of embodiments is not limited in this respect. In some embodiments, the AP 102 may contend for a TXOP during which the AP 102 is to control access to a particular channel. In some embodiments, the AP 102 may contend for a wireless medium during a contention period to receive exclusive control of the medium during a period, including but not limited to a TXOP and/or HE control period. The AP 102 may transmit, receive and/or schedule one or more frames and/or signals during the period. The STA 103 may transmit and/or receive one or more frames and/or signals during the period. However, it should be noted that embodiments are not limited to scheduled transmission/reception or to transmission/reception in accordance with the exclusive control of the medium. Accordingly, an MPDU, PPDU, BA frame and/or other frame may be transmitted/received in contention-based scenarios and/or other scenarios, in some embodiments. Any suitable contention methods, operations and/or techniques may be used, which may or may not be part of a standard. In a non-limiting example, one or more contention methods, operations and/or techniques of an 802.11 standard/protocol and/or W-LAN standard/protocol may be used.

At operation 435, the AP 102 may generate one or more MPDUs and/or MPDU fragments for transmission on the aggregated link. At operation 440, the AP 102 may assign sequence numbers (SNs) to the MPDUs and/or MPDU fragments. At operation 442, the AP 102 may transmit the one or more MPDUs and/or MPDU fragments

In some embodiments, one or more MSDUs may be allocated to a channel supported by the AP 102. Such support may be performed by a lower MAC entity implemented at the AP 102. The MPDUs and/or MPDU fragments may be generated by the AP 102 based on the MSDUs allocated to the channel. It should be noted that embodiments are not limited to a single channel, as multiple channels may be used in some cases.

In a non-limiting example, the MPDUs and/or MPDU fragments to be transmitted on a particular channel may include SNs which may be based on a transmission queuing order of the particular channel. In another non-limiting example, the MPDUs and/or MPDU fragments to be transmitted on a particular channel may include SNs which may be based on a chronological order of transmission of the particular channel.

An MPDU may further include the PN of a corresponding MSDU on which the MPDU is based. When fragmentation is used, an MPDU fragment may further include the PN of a corresponding MSDU on which the MPDU fragment is based.

In some embodiments, the SNs may be used for acknowledgement of decoded MPDUs and/or MPDU fragments by the receiving entity. The SNs may be assigned per-channel (and/or per-link), in some cases. In addition, the SNs may be assigned by corresponding lower MAC entities, in some embodiments.

The SNs may be used for per-link acknowledgement and/or per-channel acknowledgement of MPDUs. In addition, the PNs may be used by the receiving entity for reordering of decoded MSDUs and/or decoded MPDUs.

In a non-limiting example, an SN included in an MPDU may be included in a MAC header of the MPDU. The PN included in the MPDU may be included in a counter mode cipher block chaining message authentication code (CBC-MAC) protocol (CCMP) header of the MPDU or in a Galois/Counter mode protocol (GCMP) header of the MPDU. These example headers are not limiting, however, as the SNs and/or PNs may be included in any suitable header or may not necessarily be included in a header.

In some embodiments, the AP 102 may determine, based on a mechanism such as an enhanced distributed channel access (EDCA) traffic class prioritization, quality of service (QoS), other traffic prioritization and/or other mechanism, a priority of the MPDU based on a queue of MPDUs to be transmitted on the first channel. Accordingly, the assigned SNs may be based on such factors in those embodiments.

At operation 445, the AP 102 may receive acknowledgement messages for the MPDUs and/or MPDU fragments. In a non-limiting example, the acknowledgement messages may be block ACK (BA) frames, which may be included in an 802.11 standard and/or other standard. This example is not limiting, however, as any suitable acknowledgement message may be used, including a message included in another standard or a message not necessarily included in a standard.

At operation 450, the AP 102 may retransmit one or more of the MPDUs and/or MPDU fragments based on the acknowledgement messages. In some embodiments, the acknowledgement messages may include information such as ACK bits and/or indicators of whether reception of MPDU(s) and/or MPDU fragment(s) is successful. The acknowledgement messages may include information related to other MPDUs, in some cases. Additional information may also be included in the acknowledgement messages, in some cases.

In some embodiments, the AP 102 may transmit a trigger frame (TF). In a non-limiting example, the TF may indicate information to be used by the STA 103 to exchange one or more frames and/or signals (such as the PPDUs of operation 440) with the AP 102 during a transmission opportunity (TXOP). Example frames may include, but are not limited to, MPDUs, PPDUs and/or BA frames. Example information of the TF may include, but is not limited to, time resources to be used for transmission/reception, channel resources to be used for transmission/reception, identifiers of STAs 103 that are to transmit, identifiers of STAs 103 that are to receive and/or other information. It should be noted, however, that embodiments are not limited to usage of the TF, and some embodiments may not necessarily include the usage of the TF.

One or more of operations 410-450 and/or others may be performed as part of downlink communication. One or more of operations 455-475 may be performed as part of uplink communication. The AP 102 may be configured to perform operations for downlink communication or uplink communication or both.

At operation 455, the AP 102 may receive one or more uplink MPDUs and/or uplink MPDU fragments on the aggregated link. Accordingly, multiple channels, links and/or lower MAC entities may be used. As described previously regarding the downlink communication, the uplink MPDUs and/or uplink MPDU fragments may be based on an uplink sequence of MSDUs and may include PNs assigned to the uplink sequence of MSDUs. The uplink MPDUs and/or uplink MPDU fragments may further include SNs assigned per-channel (and/or per-link).

At operation 460, the AP 102 may transmit one or more acknowledgement messages, frames, blocks and/or other for the received uplink MPDUs and/or uplink MPDU fragments. The acknowledgement messages may be based on the SNs included in the uplink MPDUs and/or uplink MPDU fragments. At operation 465, the AP 102 may receive retransmissions of the uplink MPDUs and/or uplink MPDU fragments. At operation 470, the AP 102 may reassemble uplink MPDU fragments into decoded uplink MPDUs. The reassemble operation may be performed based on the SNs included in the uplink MPDUs and/or uplink MPDU fragments. At operation 475, the AP 102 may reorder decoded uplink MPDUs and/or decoded uplink MSDUs based on the PNs included in the uplink MPDUs and/or uplink MPDU fragments. It should be noted that the reordering may be performed for the decoded uplink MPDUs and/or the decoded uplink MSDUs, as the decoded uplink MSDUs are based on the decoded uplink MPDUs.

In some embodiments, systems such as W-LAN, Wi-Fi, 802.11ax, 802.11ax wave 2 and/or others may utilize link aggregation between different air interfaces on different bands (such as 2.4 GHz, 5 GHz, 60 GHz and/or others). In some cases, channels in a same frequency band may be used. Simultaneous dual band operation (such as 2.4 GHz, 5 GHz and/or other) may be used in some cases. Link aggregation may also be applicable to multiple air interfaces in the same band (for instance, two independent 802.11ac/802.11ax air interfaces at 5 GHz on two different 80 MHz channels). Embodiments are not limited to these examples, however, as techniques, operations, methods and/or concepts described herein may be extended to three bands (tri-band) or more than three bands, in some embodiments.

In some embodiments, link aggregation may be performed and/or defined at a MAC layer (or above). Multiple links between two peer STAs 103 (or between an AP 102 and an STA 103) on different bands with different air interfaces may be established. These multiple links may be aggregated, for instance, in a multi-band upper MAC defined in each of the peer STAs 103 (or between an AP 102 and an STA 103). In a non-limiting example, a fast session transfer (FST) protocol (such as defined in an 802.11ad standard and/or others) may be used for this link aggregation.

In some embodiments, link aggregation may enable the AP 102, STA 103 and/or other device to distribute a traffic flow on multiple bands/air interfaces in order to sum the throughputs from the different air interfaces. Link aggregation may also enable the AP 102, STA 103 and/or other device to direct a specific traffic type on a best air interface in terms of throughput, reliability, latency and/or other factors. In some embodiments, the link aggregation may be done transparently to one or more upper layers, in which case a single MAC SAP may be exposed to the upper layers. It may also occur on higher layers, in some embodiments. In some embodiments, distribution of packets (such as load balancing) of a single stream to multiple bands/links may be performed. In a non-limiting example, a re-ordering functionality in a multi-band upper MAC may be used.

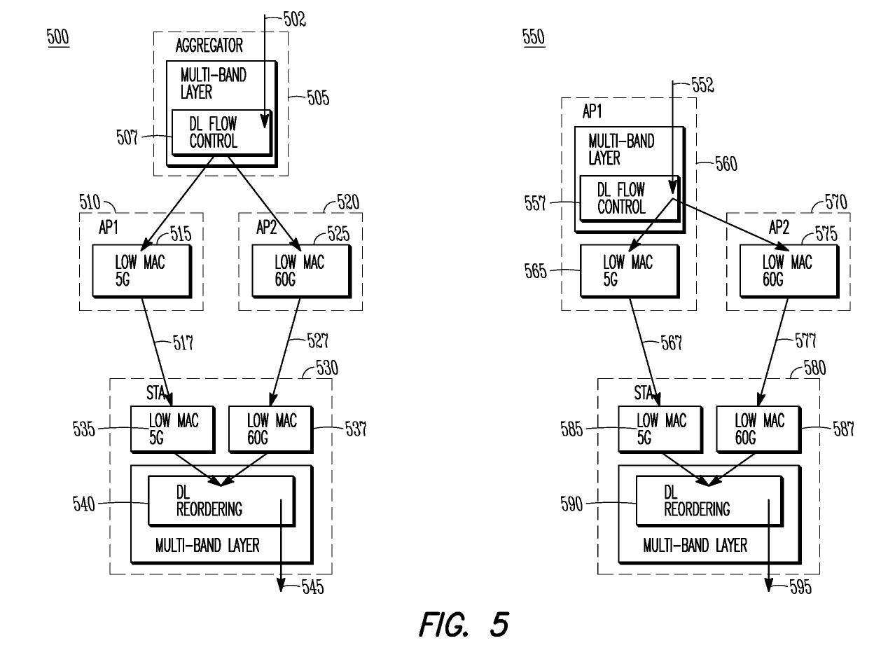

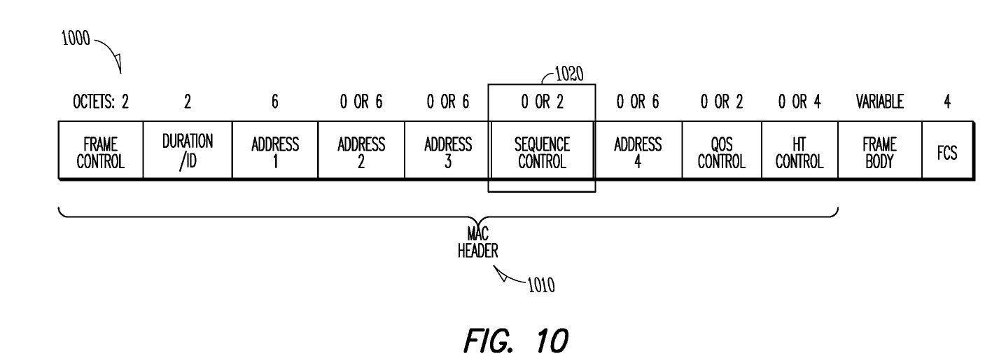

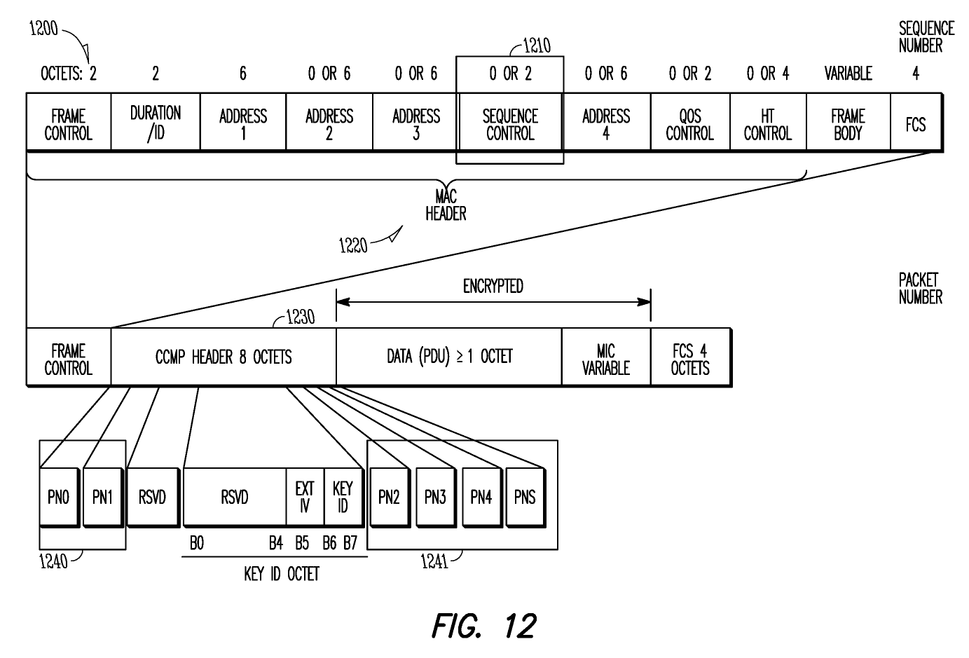

FIGS. 5-9, 11 and 13 illustrate example scenarios of link aggregation in accordance with some embodiments. FIGS. 10 and 12 illustrate example MPDUs in accordance with some embodiments. It should be noted that the examples shown in FIGS. 5-13 may illustrate some or all of the concepts and techniques described herein in some cases, but embodiments are not limited by the examples of FIGS. 5-13. For instance, embodiments are not limited by the name, number, type, size, ordering, arrangement and/or other aspects of the frames, signals, fields, data blocks, layers (such as upper MAC, lower MAC, PHY and/or other), modules, operations, time resources, channels, frequency bands, and other elements as shown in FIGS. 5-13. Although some of the elements shown in the examples of FIGS. 5-13 may be included in an 802.11 standard and/or other standard, embodiments are not limited to usage of such elements that are included in standards.

Referring to FIG. 5, the aggregator function 505 may include downlink flow control 507. The aggregator function 505 may be implemented on an infrastructure device and/or other device, in some cases. The first AP 510 may communicate at a first frequency band (such as in a 5 GHz range) and the second AP 520 may communicate at a second frequency band (such as in a 60 GHz range). Lower MAC operations (as indicated by 515 and 525) may be performed by the APs 510, 520. Packets (such as MPDUs, MPDU fragments and/or other) may be transmitted on the links 517 and 527 to the STA 530. Lower MAC operations (as indicated by 535 and 537) may be performed by the STA 530. Downlink reordering 540 may be performed by the STA 530. An output 545 (such as a reordered sequence) may be sent to one or more upper layers of the STA 530.

In the example scenario 550, a first AP 560 may perform downlink flow control (as indicated by 557). The first AP 560 may communicate at a first frequency band (such as in a 5 GHz range) and the second AP 570 may communicate at a second frequency band (such as in a 60 GHz range). Lower MAC operations (as indicated by 565 and 575) may be performed by the APs 560, 570. Packets (such as MPDUs, MPDU fragments and/or other) may be transmitted on the links 567 and 577 to the STA 580. Lower MAC operations (as indicated by 585 and 587) may be performed by the STA 580. Downlink reordering 590 may be performed by the STA 580. An output 595 (such as a reordered sequence) may be sent to one or more upper layers of the STA 580.

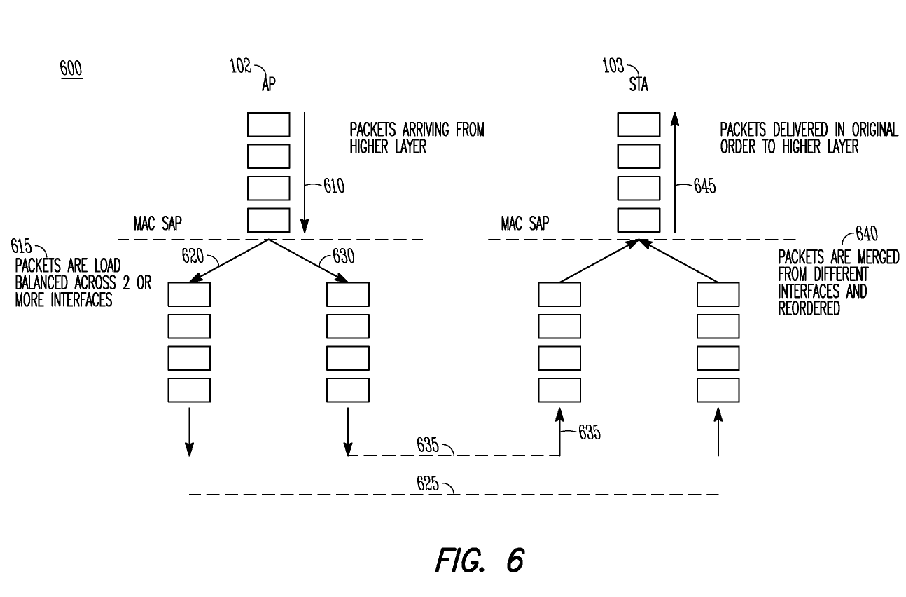

Referring to FIG. 6, an example scenario 600 is shown. In some embodiments, load balancing may be performed over two or more channels/bands/air interfaces that are sufficiently separated in frequency to enable simultaneous, independent operation and may be non-collocated (in different devices), at least on one side of the link. Examples may include, but are not limited to: a 2.4 GHz band channel and a 5 GHz band channel; two 5 GHz band channels at opposite ends of the band; a 5 GHz band channel and a 60 GHz band channel; a 2.4 GHz band channel, a 5 GHz band channel and a 60 GHz band channel.

Referring to FIG. 6, a stream of packets 610 from a higher layer is load balanced across two or more links, as indicated by 615. For instance, the first interface 620 may be used to send packets to a first queue for a first wireless link 625, and the second interface 630 may be used to send packets to a second queue for a second wireless link 635. At the remote end, the individual packet streams from each link are merged together (as indicated by 640) and delivered (as indicated by 645), in the original sequence, to the upper layer. The lower MAC and PHY on each of the links may operate independently of each other, in some cases.

In some embodiments, mechanisms to expose a single MAC address for the load balanced (aggregated) link may be used, even though the traffic may be distributed among multiple physical devices, each having their own MAC Address. A single MAC address may be presented to the higher layer so that the load balanced link is treated by the higher layers as a single logical link by which the destination is reached. This MAC address may be different from the MAC addresses used on the individual channels. Alternatively, the MAC address exposed to the higher layers may be the same as that used on one of the channels (or all, if all channels use the same MAC address, possible in the collocated scenario).

In some embodiments, on each peer STA 103 of the link, a MAC layer with its associated MAC layer management entity (MLME) and a specific MAC address may be used for the multi-band layer, which may expose a single MAC SAP to the upper layer, may split the traffic on the multiple air interfaces for a transmit flow, may collect the packets from the multiple air interfaces for a receiver flow, and may perform reordering. The single MAC SAP may perform one or more operations for the MAC layer of each air interface. In some embodiments, the multi-band layers on each side of the link may exchange management information in order to control the multi-band operation across all air interfaces. In some embodiments, communication between these multi-band layers may be used.

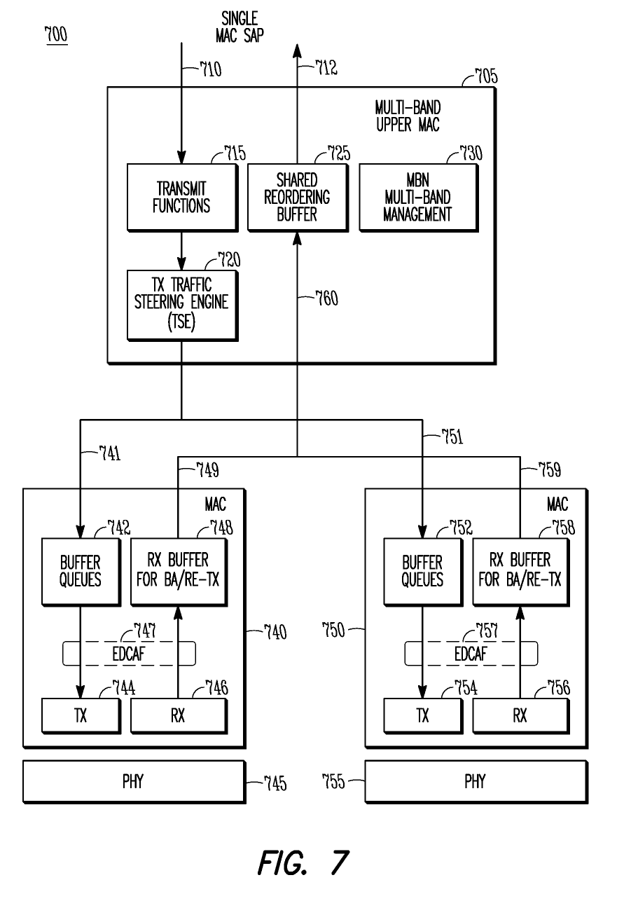

Referring to FIG. 7, on each peer STA of the link, a MAC layer with its associated MAC layer management entity (MLME) and a specific MAC address may be defined and/or used for the multi-band layer and the MAC layer of each air interface. The multi-band upper MAC 705 may include transmit function 715, transmit traffic steering engine (TSE) 720, a shared reordering buffer 725 and/or MBN multi-band management functions 730. It should be noted that one or more operations may be described in terms of the individual modules 715-730, but embodiments are not limited to usage of these particular modules 715-730 or to usage of any individual modules. The upper MAC 705 may interface to a first lower MAC 740 (which may be for a first channel and/or first band, in some cases) and to a second lower MAC 750. The first lower MAC 740 may include buffer queues 742, transmission function 744, receive function 746, and/or receive buffer 748 for block acknowledgement (BA)/retransmission operations. In addition, EDCAF 747 may be used, in some cases. The TX 744 and RX 746 may interface with the PHY layer 745. The second lower MAC 750 may include one or more operations/functions/modules which may be similar to those of lower MAC 740, although the scope of embodiments is not limited in this respect.

In some embodiments, the multi-band upper MAC 705 may expose a single MAC SAP to the upper layer. The MAC address that is exposed may be the Multi-band MLME MAC address (@SA_MB in our example). The upper MAC 705 may, for transmission: split the traffic on the multiple air interfaces for a transmit flow, perform load balancing/flow control functions, and assign to the different packets a Multi-band sequence counter. The upper MAC 705 may, for reception, collection of the packets from the multiple air interfaces for a receiver flow and perform reordering based at least partly on the multi-band sequence counters.

In some embodiments, the upper MAC 705 may perform multi-band management functions (as indicated by 730), which may include one or more of association, authentication, security, traffic load balancing between the different air interfaces (for all streams or per stream/per priority), power save management on each air interface, transitions between air interfaces, presentation of metrics representing the aggregated link to higher layers or applications. In some embodiments, the multi-band entities of each peer may therefore be capable of communicating, through the lower MAC of different interfaces of each peer and over the air, in order to manage the multi-band session.

The lower MAC 740, 750 of each interface may have reduced functions in comparison to legacy devices, in some cases. In some embodiments, the lower MACs 740, 750 may maintain the sequence number assignment for per interface block acknowledgement and selective retransmissions as well as air-interface specific MAC processing. One or more management functions may be moved from the lower MAC 740, 750 to the upper MAC 705, in some embodiments.

In some embodiments, the transmit functions 715 may comprise at least packet number (PN) assignment for reordering at the receive side. In some embodiments, the TSE 725 may distribute MSDUs to one MACx TX or to multiple MACx TXs. In some embodiments, the multi-band management functions 730 may be related to security keys, sequence counters, packet counters, management of multi-band sessions, multi-band capability exchange, multi-band session creation or suppression, power saving on different air interfaces, traffic steering and/or other. In some embodiments, the EDCAF may manage channel access. Once a channel is acquired, the EDCAF may inform the TSE 725 to get MSDUs from shared queues.

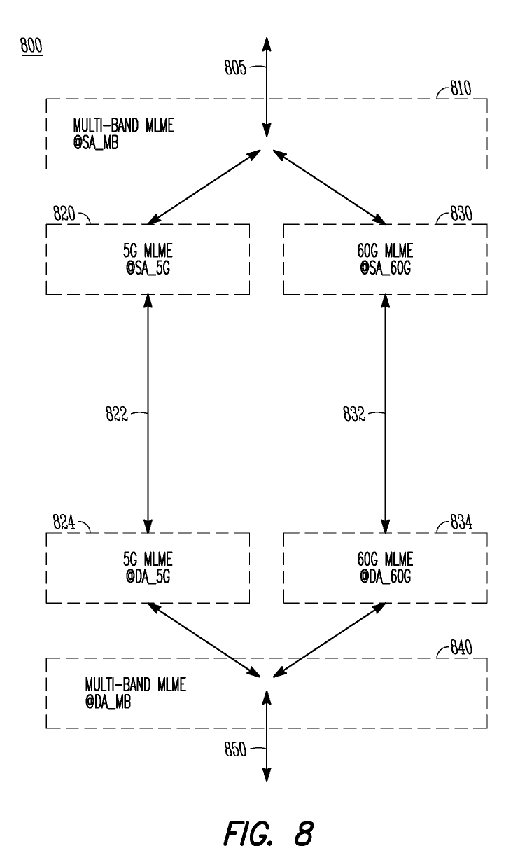

Referring to FIG. 8, the multi-band MLME 810 may use a MAC address @SA_MB (in which the “S” may refer to a “source”), the 5G MLME 820 may use the MAC address @SA_5G, the 60 GHz MLME 830 may use the MAC address @SA_60G. One or more packets may be transmitted over air interfaces 822, 832. The one or more packets may be received at the 5 GHz MLME 824 and the 60 GHz MLME 834 and forwarded to the multi-band MLME 840. The multi-band MLME 840 may use a MAC address @DA_MB (in which the “D” may refer to a “destination”), the 5G MLME 824 may use the MAC address @DA_5G, the 60 GHz MLME 834 may use the MAC address @DA_60G. In some embodiments, a same MAC address may be used for the upper MAC and for one of the lower MACs. For instance, such an arrangement may be used when the upper MAC and the particular lower MAC are collocated (such as in scenario 550 of FIG. 5).

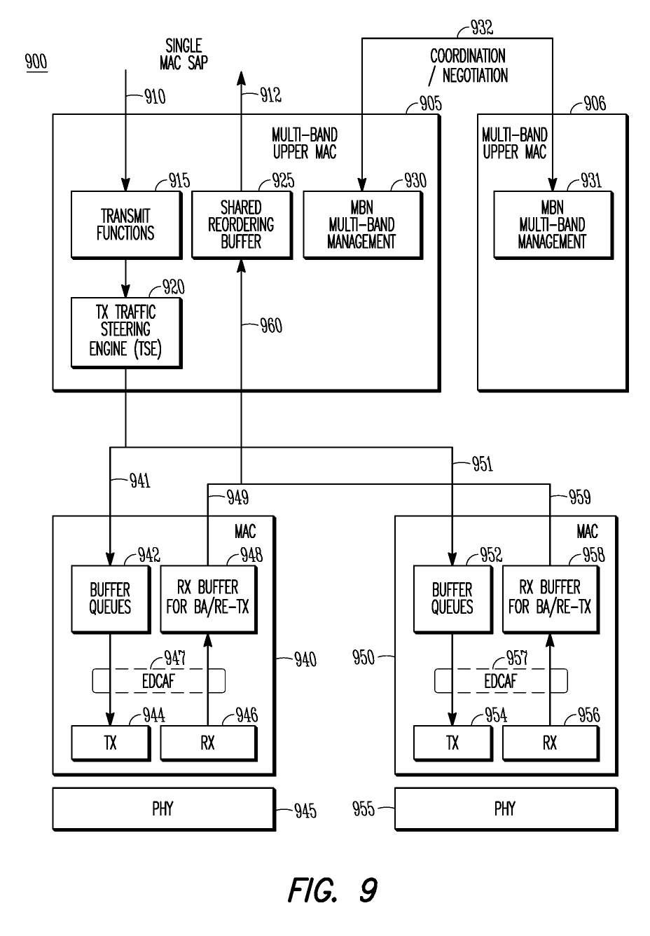

Referring to FIG. 9, multiple upper MACs 930 and 931 are shown. The first upper MAC 930 may perform functions similar to the upper MAC functions described regarding FIG. 7 and elsewhere herein, although the scope of embodiments is not limited in this respect. In the scenario 900 of FIG. 9, the two (or more in some cases) multi-band upper MACs 930 and 931 may communicate with each other to perform multi-band management (as indicated by 932). Although there is one MBM (Multi-band upper MAC) in each AP, the control of the load balancing over the lower MAC in a particular AP is not necessarily by the MBM in that particular AP. In some embodiments, there may be a Master MBM, and each lower-MAC may be mapped to one Master MBM (Multi-band upper MAC) which may not necessarily collocated with it. However, an MBM (Multi-band upper MAC) may be connected to multiple lower MACs on different devices, operating on the similar or different bands. An MBM may conduct load balancing and aggregating traffic among the lower MACs that are mapped to it. Accordingly, only a single multi-band upper MAC (the master), such as 930 in the example of FIG. 9, may have a MAC SAP that connects to the upper layers, in some cases. The multi-band upper MAC of the other APs (in other devices), such as 931 in FIG. 9, may simply function as a pass-through forwarding or receiving the packets to/from the master multi-band upper MAC 930. The reordering functions and multi-band sequence control assignment may be done in the master, in some cases. Accordingly, even if the functionalities exist in the secondary upper MAC, they may not necessarily be used, in such cases.

Different methods of selection of the master MBM may be used. In a non-limiting example, the master MBM may be negotiated among multiple upper MACs. In another non-limiting example, the master MBM may be statically allocated, such as by an administrator. With this architecture, in each device, the upper MAC and the lower MAC may have the same MAC address, as they are co-located.

In some embodiments, separate acknowledgement and reordering mechanisms may be used. As acknowledgement and reordering are done separately in such embodiments, the two functions may be performed in different places (different layers in the same device or even in different devices) in the receiver side. In a non-limiting example, sequence numbers (SNs) may be used for acknowledgements and security packet numbers (PNs) may be used for reordering. In another non-limiting example, a multi-band reordering SN may be used.

Referring to the example MPDU 1000 in FIG. 10, reordering and acknowledgement may be performed together, in some embodiments. For instance, a same field in an MPDU may be used. Referring to the example MPDU 1000 in FIG. 10, the sequence control field 1020 may be used for such purpose. It should be noted that embodiments are not limited by the number, type, ordering and/or arrangement of the fields in the example MPDU 1000. The example MPDU 1000 may be included in a standard and/or protocol such as W-LAN, 802.11 and/or other, although embodiments are not limited to usage of packets (MPDUs and/or other) included in any standard. In some embodiments, an SN may be uniquely assigned to an MSDU or aggregate MSDU (A-MSDU). The assignment may be performed in an incremental order that reflects the ordering of the MSDUs, in some cases. The SN may be inserted in the MAC header of the MPDU, in the sequence control field 1020, as illustrated in FIG. 10.

Continuing with the example MPDU 1000 in FIG. 10, re-ordering of packets at a destination may be performed such that the packets are delivered to the higher layers in the same order in which they were delivered to the MAC at the source. Packets may arrive at the destination out of order due to one or more factors, including but not limited to independent lower MAC operation (channel access delay, retransmissions and/or other factors), network activity on each of the channels and/or other.

Continuing with the example MPDU 1000 in FIG. 10, the destination STA 103 may use the SNs to acknowledge the MPDUs that have been correctly received. For instance, the destination STA 103 may inform the source STA 103 of the sequence numbers of the MPDUs that have been correctly or incorrectly received, which may trigger retransmissions, in some cases, for packets incorrectly received. The destination STA 103 may also use the SNs to reorder the MPDUs before delivering them to the upper layer.

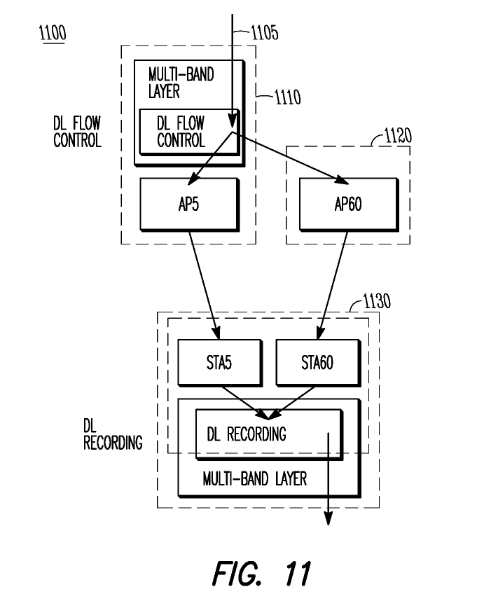

It should be noted that if the SN assignment is done on each band/interface, different SNs may be assigned on different bands, and the information of how to reorder the packets that have gone through different bands/interfaces may not be available. The MSDUs can then only be reordered per air interface/bands, in some cases. This can happen, for instance, in the scenario where the two air interfaces are in different devices on one peer STA. An example of such a scenario is shown in FIG. 11, in which a first AP 1110 may transmit packets to the STA 1130 in a first frequency band and a second AP 1120 may transmit packets to the STA 1130 in a second frequency band.

In some embodiments, separate acknowledgement and reordering mechanisms may be used. For instance, sequence numbers (SNs) may be used for acknowledgements and PNs (such as security packet numbers and/or other) may be used for reordering. As acknowledgement and reordering are done separately in some cases, the two functions may be done in different places (different layers in the same device or even in different devices) in the receiver side. The SNs may therefore be specific to one air interface (channel/band), and the PNs may be specific to the multi-band aggregated link (in the multi-band upper MAC).

In some embodiments, a series/sequence of packets arriving from a higher layer may be assigned a PN number and may be placed in a queue of one of the interfaces. Each packet may be assigned the next PN by the multi-band MAC. As each packet is queued in an interface, it may be assigned the next sequence number (SN) for that interface. At the recipient, packets may arrive on each interface and may be queued in the receive queue. If a block acknowledgement (BA) operation is in effect on that interface, then selective retransmissions may be performed on each interface. The packets may be optionally reordered as appropriate on each interface using the SNs. After the per-interface retransmission/reorder process, the recipient may perform one or more of the following functions to merge the packet flows for delivery to the higher layer. The packets from all interfaces may be released to the multi-band upper MAC buffers (note that this multi-band upper MAC can be in another device and the packets can be transported over wire or wireless with any specific method). In the multi-band upper MAC buffer, the packets may be reordered using their packet numbers (PN). Once reordered, they can be delivered in order to the upper layer.

Various issues may arise. For instance, if fragmentation is performed in the air interface MAC level, the different fragments may need to be assigned a different PN. In addition, if control or management frames are transmitted on the different air interfaces, a PN may have to be assigned also a PN. In some cases, rules to assign the PN to MPDUs may ensure that the same PN is not assigned to different MPDUs.

In order to address the issues of fragmentation, a PN number may be assigned in the multi-band upper layer to consecutive MSDUs by incrementing the PN from a previous MSDU by a predetermined amount (such as “Delta-frag”). The predetermined amount may be or may be based on a maximum number of fragments that are possible and/or permitted per MSDU. At the air interface MAC, if an MSDU with a specific PN Is fragmented, the multiple fragments may be assigned PNs in a range of (PN, PN+1, PN+Delta-frag−1). This may ensure the unicity of the PN assignment to MPDUs, in some cases.

In order to address the issue of transmission of control/management frames per air interface, consecutive MSDUs may be assigned PNs spaced apart by Delta-frag+Delta-man/con, in which “Delta-man/con” may be a maximum number of control frames and/or management frames between consecutive MSDUs. In addition, PNs may be assigned to control/management frames in each air interface MAC in incremental order starting from an offset. This offset may ensure that the PN for control/management frames in each air interfaces are different from each other (different offset per air interfaces), and also different from the PNs for data packets.

In some embodiments, CCMP or GCMP may be used. MPDU frames may include another header, the CCMP/GCMP header, as illustrated in the example MPDU 1200 in FIG. 12. The example header 1200 includes a security packet number (PN) (split into two parts 1240 and 1241 in this example), which is made of 6 bytes, and is unique to the MPDU 1200 and is incremented also following the orders of the MPDUs 1200. The security PN 1240, 1241 may be used as a PN in some cases, for reordering and/or other purposes. Embodiments are not limited to the size and/or type of the example security PN 1240, 1241, as other suitable fields may be used as a PN in some cases.

In some embodiments, an additional field may be used for reordering. For instance, a multi-band sequence number (MBSN) may be used. The SNs may be used for acknowledgement and the MBSN may be used for reordering. As acknowledgement and reordering are done separately, the two functions may be done in different places (different layers in the same device or even in different devices) in the receiver side. The SNs may therefore be specific to one air interface (channel/band). The MBSNs may be specific to the multi-band aggregated link (in the multi-band upper MAC). In some embodiments, a series/sequence of packets arriving from a higher layer may be assigned an MBSN number and may be placed in a queue of one of the interfaces. Each packet may be assigned a next MBSN by the multi-band MAC. As each packet is queued in an interface, it may be assigned the next sequence number (SN) for that interface. At the recipient, packets may arrive on each interface and may be queued in the receive queue. If a block acknowledgement (BA) operation is in effect on that interface, selective retransmissions may be performed on each interface using SN. The packets may be optionally reordered as appropriate on each interface. After the per-interface retransmission/reorder process, the recipient may perform the following functions to merge the packet flows for delivery to the higher layer. The packets from all interfaces may be released to the multi-band upper MAC buffers. Note that this multi-band upper MAC may be in another device and the packets may be transported over wire or wireless with any specific method. In the multi-band upper MAC buffer, the packets may be reordered by using their MBSN. Once reordered, they may be delivered in order to the upper layer.

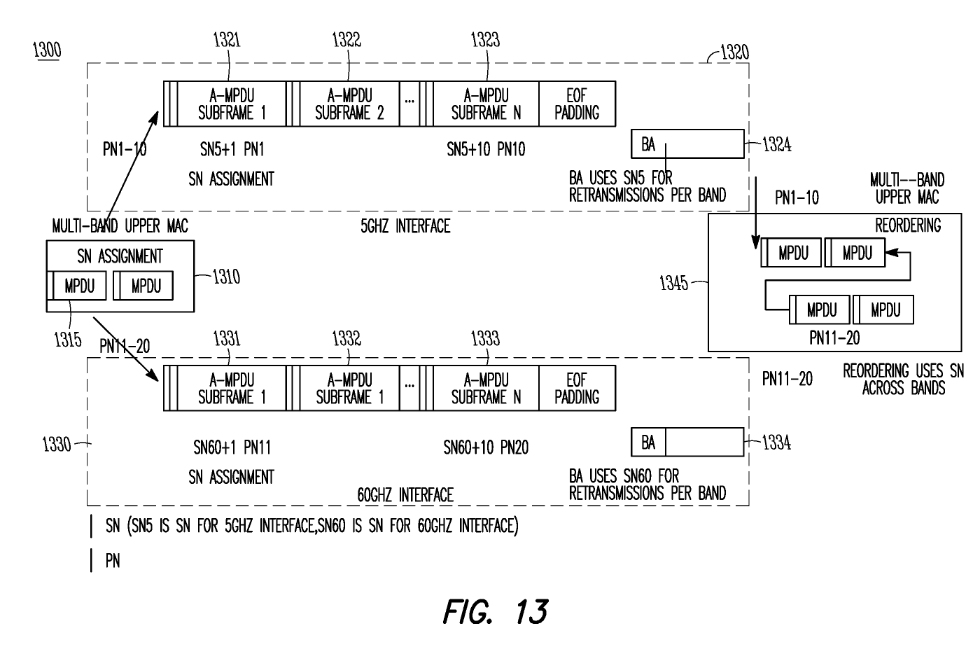

FIG. 13 illustrates assignment of PNs by the multi-band upper MAC entity 1310 and allocation to the two lower MAC entities 1320 and 1330. For instance, the multi-band upper MAC entity 1310 may be implemented at a first AP 102, the lower MAC entities 1320 and 1330 may be implanted at the first AP 102 or at a second AP 102. The reordering 1345 may be performed by the STA 103.

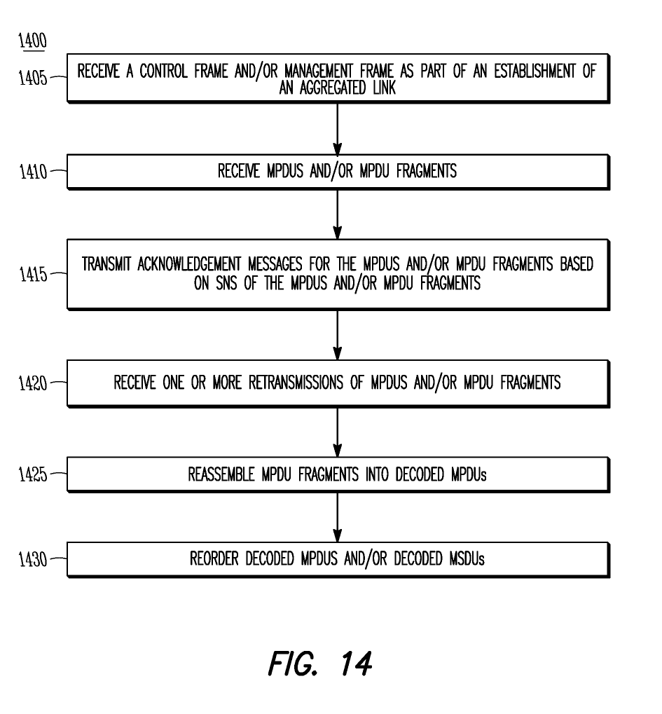

FIG. 14 illustrates the operation of another method of communication in accordance with some embodiments. As mentioned previously regarding the method 400, embodiments of the method 1400 may include additional or even fewer operations or processes in comparison to what is illustrated in FIG. 14 and embodiments of the method 1400 are not necessarily limited to the chronological order that is shown in FIG. 14. In describing the method 1400, reference may be made to FIGS. 1-13, although it is understood that the method 1400 may be practiced with any other suitable systems, interfaces and components.

In some embodiments, the STA 103 may be configurable to operate as an HE device 104. Although reference may be made to an STA 103 herein, including as part of the descriptions of the method 1400 and/or other methods described herein, it is understood that an HE device 104 and/or STA 103 configurable to operate as an HE device 104 may be used in some embodiments. In addition, embodiments of the method 1400 may be applicable to APs 102, STAs 103, UEs, eNBs or other wireless or mobile devices. The method 1400 may also be applicable to an apparatus for an AP 102, STA 103 and/or other device described above.

It should be noted that the method 400 may be practiced by an AP 102 and may include exchanging of elements, such as frames, signals, messages, fields and/or other elements, with an STA 103. Similarly, the method 1400 may be practiced at an STA 103 and may include exchanging of such elements with an AP 102. In some cases, operations and techniques described as part of the method 400 may be relevant to the method 1400. In addition, embodiments of the method 1400 may include operations performed at the STA 103 that are reciprocal to or similar to other operations described herein performed at the AP 102 as part of the method 400. For instance, an operation of the method 1400 may include reception of a frame from the AP 102 by the STA 103 while an operation of the method 400 may include transmission of the same frame or similar frame by the AP 102.

In addition, previous discussion of various techniques and concepts may be applicable to the method 1400 in some cases, including link aggregation, PNs, SNs, assignment of the PNs, assignment of the SNs, control frames, management frames, upper MAC entity, lower MAC entity, collocated entities, non-collocated entities, acknowledgement messages and/or others. In addition, one or more of the examples shown in FIGS. 5-13 may also be applicable, in some cases, although the scope of embodiments is not limited in this respect.

At operation 1405 of the method 1400, the STA 103 may receive a control frame and/or management frame as part of an establishment of an aggregated link. At operation 1410, the STA 103 may receive MPDUs and/or MPDU fragments on the aggregated link. Accordingly, multiple channels, links and/or lower MAC entities may be used. As described previously, the MPDUs and/or MPDU fragments may be based on a sequence of MSDUs and may include PNs assigned to the sequence of MSDUs. The MPDUs and/or MPDU fragments may further include SNs assigned per-channel (and/or per-link).

At operation 1415, the STA 103 may transmit acknowledgement messages for the MPDUs and/or MPDU fragments based on SNs of the MPDUs and/or MPDU fragments. The acknowledgement messages may be based on the SNs included in the MPDUs and/or MPDU fragments. At operation 1420, the STA 103 may receive one or more retransmissions of MPDUs and/or MPDU fragments. At operation 1425, the STA 103 may reassemble MPDU fragments into decoded MPDUs. The reassemble operation may be performed based on the SNs included in the MPDUs and/or MPDU fragments. At operation 1430, the STA 103 may reorder decoded MPDUs and/or decoded MSDUs based on the PNs included in the MPDUs and/or MPDU fragments. It should be noted that the reordering may be performed for the decoded MPDUs and/or the decoded MSDUs, as the decoded MSDUs are based on the decoded MPDUs.

It should be noted that some operations are described herein as part of downlink transmission of data. That is, the AP 102 (and/or multiple APs 102) may generate MPDU(s) for downlink transmission and may receive feedback from the STA 103. Embodiments are not limited to downlink transmission of data, however. In some embodiments, one or more operations and/or techniques described herein may be performed as part of uplink transmission of data.

FIG. 15 is a block diagram of a radio architecture 1500 in accordance with some embodiments. Radio architecture 1500 may include radio front-end module (FEM) circuitry 1504, radio IC circuitry 1506 and baseband processing circuitry 1508. Radio architecture 1500 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1504 may include a WLAN or Wi-Fi FEM circuitry 1504a and a Bluetooth (BT) FEM circuitry 1504b. The WLAN FEM circuitry 1504a may include a receive signal path comprising circuitry configured to operate on WLAN RF signals received from one or more antennas 1501, to amplify the received signals and to provide the amplified versions of the received signals to the WLAN radio IC circuitry 1506a for further processing. The BT FEM circuitry 1504b may include a receive signal path which may include circuitry configured to operate on BT RF signals received from one or more antennas 1502, to amplify the received signals and to provide the amplified versions of the received signals to the BT radio IC circuitry 1506b for further processing. FEM circuitry 1504a may also include a transmit signal path which may include circuitry configured to amplify WLAN signals provided by the radio IC circuitry 1506a for wireless transmission by one or more of the antennas 1501. In addition, FEM circuitry 1504b may also include a transmit signal path which may include circuitry configured to amplify BT signals provided by the radio IC circuitry 1506b for wireless transmission by the one or more antennas. In the embodiment of FIG. 15, although FEM 1504a and FEM 1504b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1506 as shown may include WLAN radio IC circuitry 1506a and BT radio IC circuitry 1506b. The WLAN radio IC circuitry 1506a may include a receive signal path which may include circuitry to down-convert WLAN RF signals received from the FEM circuitry 1504a and provide baseband signals to WLAN baseband processing circuitry 1508a. BT radio IC circuitry 1506b may in turn include a receive signal path which may include circuitry to down-convert BT RF signals received from the FEM circuitry 1504b and provide baseband signals to BT baseband processing circuitry 1508b. WLAN radio IC circuitry 1506a may also include a transmit signal path which may include circuitry to up-convert WLAN baseband signals provided by the WLAN baseband processing circuitry 1508a and provide WLAN RF output signals to the FEM circuitry 1504a for subsequent wireless transmission by the one or more antennas 1501. BT radio IC circuitry 1506b may also include a transmit signal path which may include circuitry to up-convert BT baseband signals provided by the BT baseband processing circuitry 1508b and provide BT RF output signals to the FEM circuitry 1504b for subsequent wireless transmission by the one or more antennas 1501. In the embodiment of FIG. 15, although radio IC circuitries 1506a and 1506b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1508 may include a WLAN baseband processing circuitry 1508a and a BT baseband processing circuitry 1508b. The WLAN baseband processing circuitry 1508a may include a memory, such as, for example, a set of RAM arrays in a Fast Fourier Transform or Inverse Fast Fourier Transform block (not shown) of the WLAN baseband processing circuitry 1508a. Each of the WLAN baseband circuitry 1508a and the BT baseband circuitry 1508b may further include one or more processors and control logic to process the signals received from the corresponding WLAN or BT receive signal path of the radio IC circuitry 1506, and to also generate corresponding WLAN or BT baseband signals for the transmit signal path of the radio IC circuitry 1506. Each of the baseband processing circuitries 1508a and 1508b may further include physical layer (PHY) and medium access control layer (MAC) circuitry, and may further interface with application processor 1510 for generation and processing of the baseband signals and for controlling operations of the radio IC circuitry 1506.

Referring still to FIG. 15, according to the shown embodiment, WLAN-BT coexistence circuitry 1513 may include logic providing an interface between the WLAN baseband circuitry 1508a and the BT baseband circuitry 1508b to enable use cases requiring WLAN and BT coexistence. In addition, a switch 1503 may be provided between the WLAN FEM circuitry 1504a and the BT FEM circuitry 1504b to allow switching between the WLAN and BT radios according to application needs. In addition, although the antennas 1501 are depicted as being respectively connected to the WLAN FEM circuitry 1504a and the BT FEM circuitry 1504b, embodiments include within their scope the sharing of one or more antennas as between the WLAN and BT FEMs, or the provision of more than one antenna connected to each of FEM 1504a or 1504b.

In some embodiments, the front-end module circuitry 1504, the radio IC circuitry 1506, and baseband processing circuitry 1508 may be provided on a single radio card, such as wireless radio card 1502. In some other embodiments, the one or more antennas 1501, the FEM circuitry 1504 and the radio IC circuitry 1506 may be provided on a single radio card. In some other embodiments, the radio IC circuitry 1506 and the baseband processing circuitry 1508 may be provided on a single chip or integrated circuit (IC), such as IC 1512.

In some embodiments, the wireless radio card 1502 may include a WLAN radio card and may be configured for Wi-Fi communications, although the scope of the embodiments is not limited in this respect. In some of these embodiments, the radio architecture 1500 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 1500 may be part of a Wi-Fi communication station (STA) such as a wireless access point (AP), a base station or a mobile device including a Wi-Fi device. In some of these embodiments, radio architecture 1500 may be configured to transmit and receive signals in accordance with specific communication standards and/or protocols, such as any of the Institute of Electrical and Electronics Engineers (IEEE) standards including, 802.11n-2009, IEEE 802.11-2012, 802.11n-2009, 802.11ac, and/or 802.11ax standards and/or proposed specifications for WLANs, although the scope of embodiments is not limited in this respect. Radio architecture 1500 may also be suitable to transmit and/or receive communications in accordance with other techniques and standards.

In some embodiments, the radio architecture 1500 may be configured for high-efficiency (HE) Wi-Fi (HEW) communications in accordance with the IEEE 802.11ax standard. In these embodiments, the radio architecture 1500 may be configured to communicate in accordance with an OFDMA technique, although the scope of the embodiments is not limited in this respect.

In some other embodiments, the radio architecture 1500 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 15, the BT baseband circuitry 1508b may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 15, the radio architecture 1500 may be configured to establish a BT synchronous connection oriented (SCO) link and or a BT low energy (BT LE) link. In some of the embodiments that include functionality, the radio architecture 1500 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 15, the functions of a BT radio card and WLAN radio card may be combined on a single wireless radio card, such as single wireless radio card 1502, although embodiments are not so limited, and include within their scope discrete WLAN and BT radio cards.

In some embodiments, the radio-architecture 1500 may include other radio cards, such as a cellular radio card configured for cellular (e.g., 3GPP such as LTE, LTE-Advanced or 5G communications).

In some IEEE 802.11 embodiments, the radio architecture 1500 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

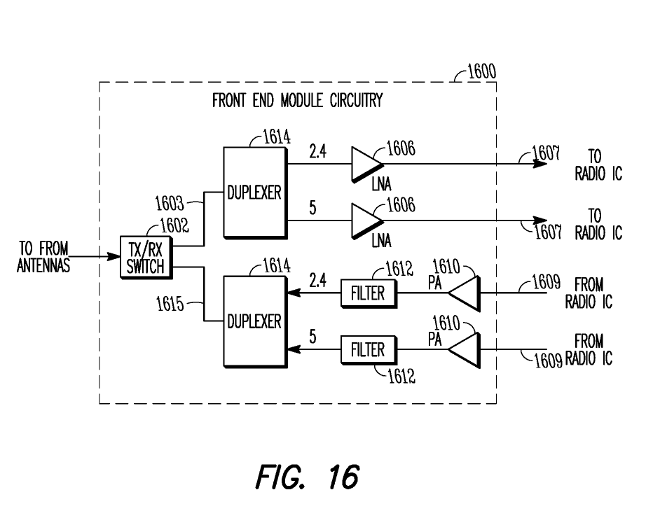

FIG. 16 illustrates FEM circuitry 1600 in accordance with some embodiments. The FEM circuitry 1600 is one example of circuitry that may be suitable for use as the WLAN and/or BT FEM circuitry 1504a/1504b (FIG. 15), although other circuitry configurations may also be suitable.

In some embodiments, the FEM circuitry 1600 may include a TX/RX switch 1602 to switch between transmit mode and receive mode operation. The FEM circuitry 1600 may include a receive signal path and a transmit signal path. The receive signal path of the FEM circuitry 1600 may include a low-noise amplifier (LNA) 1606 to amplify received RF signals 1603 and provide the amplified received RF signals 1607 as an output (e.g., to the radio IC circuitry 1506 (FIG. 15)). The transmit signal path of the circuitry 1600 may include a power amplifier (PA) to amplify input RF signals 1609 (e.g., provided by the radio IC circuitry 1506), and one or more filters 1612, such as band-pass filters (BPFs), low-pass filters (LPFs) or other types of filters, to generate RF signals 1615 for subsequent transmission (e.g., by one or more of the antennas 1501 (FIG. 15)).

In some dual-mode embodiments for Wi-Fi communication, the FEM circuitry 1600 may be configured to operate in either the 2.4 GHz frequency spectrum or the 5 GHz frequency spectrum. In these embodiments, the receive signal path of the FEM circuitry 1600 may include a receive signal path duplexer 1604 to separate the signals from each spectrum as well as provide a separate LNA 1606 for each spectrum as shown. In these embodiments, the transmit signal path of the FEM circuitry 1600 may also include a power amplifier 1610 and a filter 1612, such as a BPF, a LPF or another type of filter for each frequency spectrum and a transmit signal path duplexer 1614 to provide the signals of one of the different spectrums onto a single transmit path for subsequent transmission by the one or more of the antennas 1501 (FIG. 15). In some embodiments, BT communications may utilize the 2.4 GHZ signal paths and may utilize the same FEM circuitry 1600 as the one used for WLAN communications.

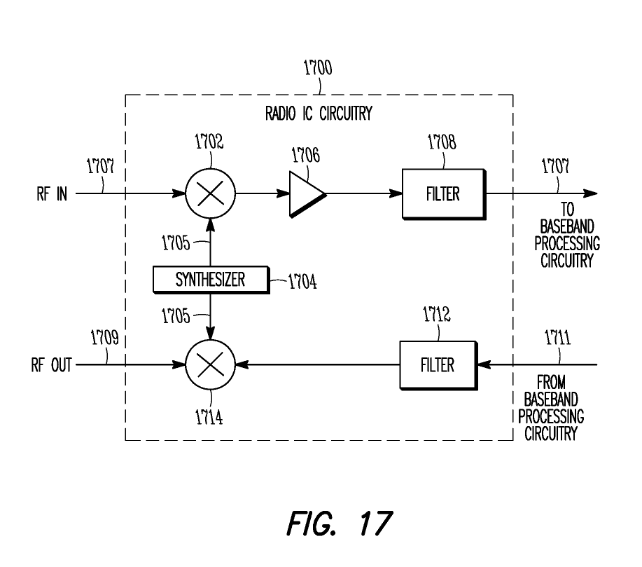

FIG. 17 illustrates radio IC circuitry 1700 in accordance with some embodiments. The radio IC circuitry 1700 is one example of circuitry that may be suitable for use as the WLAN or BT radio IC circuitry 1506a/1506b (FIG. 15), although other circuitry configurations may also be suitable.

In some embodiments, the radio IC circuitry 1700 may include a receive signal path and a transmit signal path. The receive signal path of the radio IC circuitry 1700 may include at least mixer circuitry 1702, such as, for example, down-conversion mixer circuitry, amplifier circuitry 1706 and filter circuitry 1708. The transmit signal path of the radio IC circuitry 1700 may include at least filter circuitry 1712 and mixer circuitry 1714, such as, for example, up-conversion mixer circuitry. Radio IC circuitry 1700 may also include synthesizer circuitry 1704 for synthesizing a frequency 1705 for use by the mixer circuitry 1702 and the mixer circuitry 1714. The mixer circuitry 1702 and/or 1714 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 17 illustrates only a simplified version of a radio IC circuitry, and may include, although not shown, embodiments where each of the depicted circuitries may include more than one component. For instance, mixer circuitry 1720 and/or 1714 may each include one or more mixers, and filter circuitries 1708 and/or 1712 may each include one or more filters, such as one or more BPFs and/or LPFs according to application needs. For example, when mixer circuitries are of the direct-conversion type, they may each include two or more mixers.

In some embodiments, mixer circuitry 1702 may be configured to down-convert RF signals 1607 received from the FEM circuitry 1504 (FIG. 15) based on the synthesized frequency 1705 provided by synthesizer circuitry 1704. The amplifier circuitry 1706 may be configured to amplify the down-converted signals and the filter circuitry 1708 may include a LPF configured to remove unwanted signals from the down-converted signals to generate output baseband signals 1707. Output baseband signals 1707 may be provided to the baseband processing circuitry 1508 (FIG. 15) for further processing. In some embodiments, the output baseband signals 1707 may be zero-frequency baseband signals, although this is not a requirement. In some embodiments, mixer circuitry 1702 may comprise passive mixers, although the scope of the embodiments is not limited in this respect.

In some embodiments, the mixer circuitry 1714 may be configured to up-convert input baseband signals 1711 based on the synthesized frequency 1705 provided by the synthesizer circuitry 1704 to generate RF output signals 1609 for the FEM circuitry 1504. The baseband signals 1711 may be provided by the baseband processing circuitry 1508 and may be filtered by filter circuitry 1712. The filter circuitry 1712 may include a LPF or a BPF, although the scope of the embodiments is not limited in this respect.

In some embodiments, the mixer circuitry 1702 and the mixer circuitry 1714 may each include two or more mixers and may be arranged for quadrature down-conversion and/or up-conversion respectively with the help of synthesizer 1704. In some embodiments, the mixer circuitry 1702 and the mixer circuitry 1714 may each include two or more mixers each configured for image rejection (e.g., Hartley image rejection). In some embodiments, the mixer circuitry 1702 and the mixer circuitry 1714 may be arranged for direct down-conversion and/or direct up-conversion, respectively. In some embodiments, the mixer circuitry 1702 and the mixer circuitry 1714 may be configured for super-heterodyne operation, although this is not a requirement.

Mixer circuitry 1702 may comprise, according to one embodiment: quadrature passive mixers (e.g., for the in-phase (I) and quadrature phase (Q) paths). In such an embodiment, RF input signal 1607 from FIG. 17 may be down-converted to provide I and Q baseband output signals to be sent to the baseband processor.

Quadrature passive mixers may be driven by zero and ninety degree time-varying LO switching signals provided by a quadrature circuitry which may be configured to receive a LO frequency (f_{LO}) from a local oscillator or a synthesizer, such as LO frequency 1705 of synthesizer 1704 (FIG. 17). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 1607 (FIG. 16) may comprise a balanced signal, although the scope of the embodiments is not limited in this respect. The I and Q baseband output signals may be provided to low-nose amplifier, such as amplifier circuitry 1706 (FIG. 17) or to filter circuitry 1708 (FIG. 17).

In some embodiments, the output baseband signals 1707 and the input baseband signals 1711 may be analog baseband signals, although the scope of the embodiments is not limited in this respect. In some alternate embodiments, the output baseband signals 1707 and the input baseband signals 1711 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1704 may be a fractional-N synthesizer or a fractional N/N+1 synthesizer, although the scope of the embodiments is not limited in this respect as other types of frequency synthesizers may be suitable. For example, synthesizer circuitry 1704 may be a delta-sigma synthesizer, a frequency multiplier, or a synthesizer comprising a phase-locked loop with a frequency divider. According to some embodiments, the synthesizer circuitry 1704 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1704 may be provided by a voltage controlled oscillator (VCO), although that is not a requirement. A divider control input may further be provided by either the baseband processing circuitry 1508 (FIG. 15) or the application processor 1510 (FIG. 15) depending on the desired output frequency 1705. In some embodiments, a divider control input (e.g., N) may be determined from a look-up table (e.g., within a Wi-Fi card) based on a channel number and a channel center frequency as determined or indicated by the application processor 1510.

In some embodiments, synthesizer circuitry 1704 may be configured to generate a carrier frequency as the output frequency 1705, while in other embodiments, the output frequency 1705 may be a fraction of the carrier frequency (e.g., one-half the carrier frequency, one-third the carrier frequency). In some embodiments, the output frequency 1705 may be a LO frequency (f_{LO}).

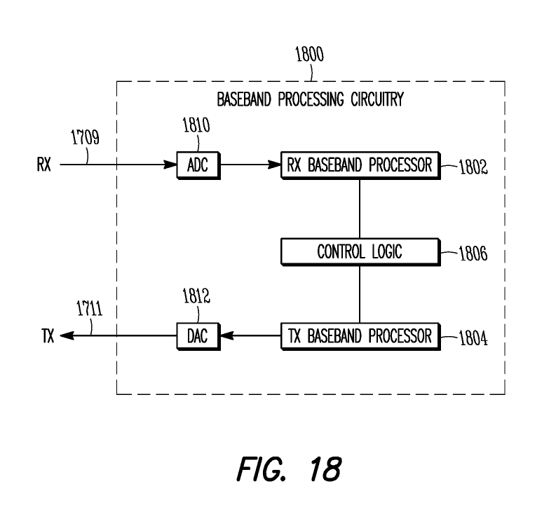

FIG. 18 illustrates a functional block diagram of baseband processing circuitry 1800 in accordance with some embodiments. The baseband processing circuitry 1800 is one example of circuitry that may be suitable for use as the baseband processing circuitry 1508 (FIG. 15), although other circuitry configurations may also be suitable. The baseband processing circuitry 1800 may include a receive baseband processor (RX BBP) 1802 for processing receive baseband signals 1709 provided by the radio IC circuitry 1506 (FIG. 15) and a transmit baseband processor (TX BBP) 1804 for generating transmit baseband signals 1711 for the radio IC circuitry 1506. The baseband processing circuitry 1800 may also include control logic 1806 for coordinating the operations of the baseband processing circuitry 1800.

In some embodiments (e.g., when analog baseband signals are exchanged between the baseband processing circuitry 1800 and the radio IC circuitry 1506), the baseband processing circuitry 1800 may include ADC 1810 to convert analog baseband signals received from the radio IC circuitry 1506 to digital baseband signals for processing by the RX BBP 1802. In these embodiments, the baseband processing circuitry 1800 may also include DAC 1812 to convert digital baseband signals from the TX BBP 1804 to analog baseband signals.

In some embodiments that communicate OFDM signals or OFDMA signals, such as through baseband processor 1508a, the transmit baseband processor 1804 may be configured to generate OFDM or OFDMA signals as appropriate for transmission by performing an inverse fast Fourier transform (IFFT). The receive baseband processor 1802 may be configured to process received OFDM signals or OFDMA signals by performing an FFT. In some embodiments, the receive baseband processor 1802 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 15, in some embodiments, the antennas 1501 (FIG. 15) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1501 may each include a set of phased-array antennas, although embodiments are not so limited.

Although the radio-architecture 1500 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In Example 1, an apparatus of an access point (AP) may comprise memory. The apparatus may further comprise processing circuitry. The processing circuitry may be configured to encode, for transmission, a control frame to establish an aggregated link for a first channel and a second channel. The aggregated link may be aggregated at an upper medium access control (MAC) entity configured to communicate control information for the aggregated link to a first lower MAC entity for the first channel and to a second lower MAC entity for the second channel. The processing circuitry may be further configured to implement the upper MAC entity and the first lower MAC entity. The processing circuitry may be further configured to, at the upper MAC entity, assign packet numbers (PNs) to a sequence of MAC service data units (MSDUs) for the aggregated link. The processing circuitry may be further configured to, at the upper MAC entity, allocate the MSDUs to the channels in accordance with a load balance of data traffic on the channels. The processing circuitry may be further configured to contend for a transmission opportunity (TXOP) to obtain access to the first channel. The processing circuitry may be further configured to, at the first lower MAC entity, generate, for transmission within the TXOP on the first channel, a MAC protocol data unit (MPDU) that includes a sequence number (SN) based on a transmission queuing order of the first channel and further includes the PN of a corresponding MSDU on which the MPDU is based.

In Example 2, the subject matter of Example 1, wherein in a first configuration of the aggregated link: the first and second channels may be configured for communication of data from the AP to a station (STA). The processing circuitry may be further configured to implement the second lower MAC entity. In a second configuration of the aggregated link: the first channel may be configured for communication of first data from the AP to the STA, the second channel may be configured for communication of second data from another AP to the STA, and the second data may be forwarded from the AP to the other AP. The second lower MAC entity may be external to the AP.

In Example 3, the subject matter of one or any combination of Examples 1-2, wherein the TXOP is a first TXOP, the MPDU is a first MPDU, and the SN is a first SN. The processing circuitry may be further configured to implement the second lower MAC entity. The processing circuitry may be further configured to, at the second lower MAC entity, generate, for transmission within a second TXOP on the second channel, a second MPDU that includes a second SN based on a transmission queuing order of the second channel and further includes the PN of a corresponding MSDU on which the second MPDU is based.

In Example 4, the subject matter of one or any combination of Examples 1-3, wherein the second lower MAC entity may be external to the AP. The processing circuitry may be further configured to, at the upper MAC entity, forward, to the second lower MAC entity, a particular MSDU that is allocated to the second channel and the PN assigned to the particular MSDU.

In Example 5, the subject matter of one or any combination of Examples 1-4, wherein the processing circuitry is further configured to, at the upper MAC entity, forward a same MAC address to the first and second lower MAC entities for inclusion in MPDUs of the first and second lower MAC entities.

In Example 6, the subject matter of one or any combination of Examples 1-5, wherein the PNs may be for reordering of decoded MSDUs. The SN of the MPDU may be for an acknowledgement of decoded MPDUs on the first channel.

In Example 7, the subject matter of one or any combination of Examples 1-6, wherein the aggregated link may be configurable for channels in a same frequency band or for channels in multiple frequency bands.

In Example 8, the subject matter of one or any combination of Examples 1-7, wherein the aggregated link may be configurable for a particular configuration wherein: the first channel is configured for usage by the AP for communication with a station (STA) in a first frequency band, and the second channel is configured for usage by another AP for communication with the STA in a second frequency band.

In Example 9, the subject matter of one or any combination of Examples 1-8, wherein the AP may be arranged to operate in accordance with a wireless local area network (WLAN) protocol.

In Example 10, the subject matter of one or any combination of Examples 1-9, wherein the processing circuitry may be further configured to determine, based on an enhanced distributed channel access (EDCA) traffic class prioritization, a priority of the MPDU based on a queue of MPDUs to be transmitted on the first channel.

In Example 11, the subject matter of one or any combination of Examples 1-10, wherein the processing circuitry may include a baseband processor to encode the control frame, assign the PNs, allocate the MSDUs, and generate the MPDU.

In Example 12, the subject matter of one or any combination of Examples 1-11, wherein the apparatus may further include a transceiver to transmit the MPDU.

In Example 13, a non-transitory computer-readable storage medium may store instructions for execution by one or more processors to perform operations for communication by an access point (AP). The operations may configure the one or more processors to encode, for transmission, a control frame to establish an aggregated link for communication on a plurality of channels. The operations may further configure the one or more processors to decode medium access control (MAC) protocol data units (MPDUs) received on one or more channels of the plurality. The operations may further configure the one or more processors to encode, for transmission, one or more block acknowledgement (BA) frames that include reception information for the MPDUs based on per-channel sequence numbers (SNs) included in the MPDUs. The operations may further configure the one or more processors to decode MAC service data units (MSDUs) based on the decoded MPDUs. The operations may further configure the one or more processors to reorder the decoded MSDUs based at least partly on packet numbers (PNs) included in the decoded MPDUs.

In Example 14, the subject matter of Example 13, wherein the one or more channels on which the MPDUs are received from the STA may be a first portion of the channels for which the AP is configured to communicate with a station (STA). The MSDUs are first MSDUs. The PNs included in the decoded MPDUs are first PNs. The operations may further configure the one or more processors to decode second MSDUs received from another AP configured to communicate with the STA on a second portion of the channels. The operations may further configure the one or more processors to reorder the first and second MSDUs based on the first PNs and further based on second PNs included in the second MSDUs.

In Example 15, the subject matter of one or any combination of Examples 13-14, wherein the aggregated link may be configurable for a particular configuration wherein a first channel used for communication between the AP and the STA is in a first frequency band, and a second channel used by the other AP for communication with the STA is in a second frequency band.

In Example 16, a method of communication at an access point (AP) may comprise assigning packet numbers (PNs) to medium access control (MAC) service data units (MSDUs) to be sent on an aggregated link comprising a plurality of channels. A first portion of the channels may be supported by the AP and a second portion of the channels are supported by another AP. The method may further comprise sending a second portion of the MSDUs to the other AP for transmission on the second portion of the channels. The method may further comprise allocating the first portion of the MSDUs to the first portion of the channels in accordance with a load balance of data traffic on the first portion of the channels. The method may further comprise contending for a transmission opportunity (TXOP) to obtain access to at least one particular channel of the first portion of the channels. The method may further comprise generating, for transmission within the TXOP on the particular channel, a MAC protocol data unit (MPDU) based on one of the MSDUs that is allocated to the particular channel. The MPDU may include a sequence number (SN) based on a transmission queuing order of the particular channel, and the MPDU further includes the PN assigned to the MSDU on which the MPDU is based.

In Example 17, the subject matter of Example 16, wherein the aggregated link may be configurable for a particular configuration wherein the first portion of the channels are in a first frequency band, and the second portion of the channels are in a second frequency band.

In Example 18, an apparatus of an access point (AP) may comprise memory. The apparatus may further comprise processing circuitry. The processing circuitry may be configured to contend for a transmission opportunity (TXOP) to obtain access to a particular link of an aggregated link comprising a plurality of links. The processing circuitry may be further configured to assign packet numbers (PNs) to a sequence of medium access control (MAC) service data units (MSDUs). The PNs assigned to consecutive MSDUs may be spaced apart by a predetermined PN spacing, wherein the PN spacing is configurable to a value greater than or equal to one. The processing circuitry may be further configured allocate the MSDUs to the links of the plurality. The processing circuitry may be further configured to generate, for transmission on the particular link within the TXOP, a MAC protocol data unit (MPDU) based on one of the MSDUs allocated to the particular link. The MPDU may include the PN of the MSDU on which the MPDU is based. The MPDU may further include a sequence number (SN) based at least partly on a chronological order of transmission on the particular link.

In Example 19, the subject matter of Example 18, wherein the PNs may be for reordering of the MSDUs of the sequence. The SN may be for per-link acknowledgement of MPDUs.

In Example 20, the subject matter of one or any combination of Examples 18-19, wherein the PN spacing may be based at least partly on a maximum number of MPDU fragments into which MPDUs are to be fragmented.

In Example 21, the subject matter of one or any combination of Examples 18-20, wherein the MSDU on which the MPDU is based is a first MSDU. The processing circuitry may be further configured to generate, for transmission on the particular link, a sequence of MPDU fragments based on a second MSDU allocated to the particular link. A number of MPDU fragments in the sequence may be less than or equal to the maximum number of MPDU fragments. Consecutive MPDU fragments of the sequence may include consecutive PNs. A starting MPDU fragment of the sequence may include the PN of the second MSDU. The MPDU fragments may further include SNs based at least partly on the chronological order of transmission on the particular link.

In Example 22, the subject matter of one or any combination of Examples 18-21, wherein the PN spacing may be based at least partly on a maximum number of control frames or management frames that may be sent by the AP between consecutive MSDUs. The processing circuitry may be further configured to encode a control frame or management frame for transmission between a first MPDU and a second MPDU. The first MPDU may be based on a first MSDU that is assigned a first PN. The second MPDU may be based on a second MSDU that is assigned a second PN. The control frame or management frame may include a PN that is between the first and second PNs.

In Example 23, the subject matter of one or any combination of Examples 18-22, wherein the links of the aggregated link may be between the AP and a station (STA). The aggregated link may be configurable for links supported in a same frequency band or for links supported in different frequency bands.

In Example 24, the subject matter of one or any combination of Examples 18-23, wherein the particular link of the aggregated link may be between the AP and a station (STA). Another link of the aggregated link may be between the STA and another AP. The processing circuitry may be further configured to forward, to the other AP, an MSDU that is allocated to the other link.

In Example 25, the subject matter of one or any combination of Examples 18-24, wherein the SN included in the MPDU may be included in a medium access control (MAC) header of the MPDU. The PN included in the MPDU may be included in a counter mode cipher block chaining message authentication code (CBC-MAC) protocol (CCMP) header of the MPDU or in a Galois/Counter mode protocol (GCMP) header of the MPDU.

In Example 26, an apparatus of a station (STA) may comprise memory. The apparatus may further comprise processing circuitry. The processing circuitry may be configured to decode medium access control (MAC) protocol data units (MPDUs) received on a plurality of links of an aggregated link. The MPDUs may include packet numbers (PNs) based on a sequence of MAC service data units (MSDUs) on which the MPDUs are based. The MPDUs may further include sequence numbers (SNs) based on per-link chronological orders of transmission on the links. The processing circuitry may be further configured to encode a block acknowledgement (BA) frame that includes reception information for the received MPDUs. The reception information may be based on the SNs of the MPDUs. The processing circuitry may be further configured to decode MSDUs based on the decoded MPDUs. The processing circuitry may be further configured to determine a reordered sequence of MSDUs that includes the decoded MSDUs reordered based on the PNs of the decoded MPDUs.

In Example 27, the subject matter of Example 26, wherein the processing circuitry may be further configured to decode MPDU fragments received on the plurality of links. The MPDU fragments may include PNs based on the sequence of MSDUs and further include SNs based on the per-link chronological orders of transmission. The processing circuitry may be further configured to reassemble the MPDU fragments into decoded MPDUs based at least partly on the PNs of the MPDU fragments.

In Example 28, the subject matter of one or any combination of Examples 26-27, wherein the links of the aggregated link may be between the STA and one or more access points (APs). The aggregated link may be configurable for links supported in a same frequency band or for links supported in different frequency bands.

In Example 29, an apparatus of an access point (AP) may comprise means for encoding, for transmission, a control frame to establish an aggregated link for communication on a plurality of channels. The apparatus may further comprise means for decoding medium access control (MAC) protocol data units (MPDUs) received on one or more channels of the plurality. The apparatus may further comprise means for encoding, for transmission, one or more block acknowledgement (BA) frames that include reception information for the MPDUs based on per-channel sequence numbers (SNs) included in the MPDUs. The apparatus may further comprise means for decoding MAC service data units (MSDUs) based on the decoded MPDUs. The apparatus may further comprise means for reordering the decoded MSDUs based at least partly on packet numbers (PNs) included in the decoded MPDUs.

In Example 30, the subject matter of Example 29, wherein the one or more channels on which the MPDUs are received from the STA may be a first portion of the channels for which the AP is configured to communicate with a station (STA). The MSDUs are first MSDUs. The PNs included in the decoded MPDUs are first PNs. The apparatus may further comprise means for decoding second MSDUs received from another AP configured to communicate with the STA on a second portion of the channels. The apparatus may further comprise means for reordering the first and second MSDUs based on the first PNs and further based on second PNs included in the second MSDUs.

In Example 31, the subject matter of one or any combination of Examples 29-30, wherein the aggregated link may be configurable for a particular configuration wherein a first channel used for communication between the AP and the STA is in a first frequency band, and a second channel used by the other AP for communication with the STA is in a second frequency band.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point (AP), the apparatus comprising: memory; and processing circuitry, configured to:
encode, for transmission, a control frame to establish an aggregated link for a first channel and a second channel, wherein the aggregated link is aggregated at an upper medium access control (MAC) entity configured to communicate control information for the aggregated link to a first lower MAC entity for the first channel and to a second lower MAC entity for the second channel;
implement the upper MAC entity and the first lower MAC entity;
at the upper MAC entity, assign packet numbers (PNs) to a sequence of MAC service data units (MSDUs) for the aggregated link;
at the upper MAC entity, allocate the MSDUs to the channels in accordance with a load balance of data traffic on the channels;
contend for a transmission opportunity (TXOP) to obtain access to the first channel; and
at the first lower MAC entity, generate, for transmission within the TXOP on the first channel, a MAC protocol data unit (MPDU) that includes a sequence number (SN) based on a transmission queuing order of the first channel and further includes the PN of a corresponding MSDU on which the MPDU is based.

2. The apparatus according to claim 1, wherein:
in a first configuration of the aggregated link:
the first and second channels are configured for communication of data from the AP to a station (STA), and
the processing circuitry is further configured to implement the second lower MAC entity,
in a second configuration of the aggregated link:
the first channel is configured for communication of first data from the AP to the STA,
the second channel is configured for communication of second data from another AP to the STA, the second data forwarded from the AP to the other AP, and
the second lower MAC entity is external to the AP.

3. The apparatus according to claim 1, wherein:
the TXOP is a first TXOP, the MPDU is a first MPDU, the SN is a first SN,
the processing circuitry is further configured to:
implement the second lower MAC entity;
at the second lower MAC entity, generate, for transmission within a second TXOP on the second channel, a second MPDU that includes a second SN based on a transmission queuing order of the second channel and further includes the PN of a corresponding MSDU on which the second MPDU is based.

4. The apparatus according to claim 1, wherein:
the second lower MAC entity is external to the AP,
the processing circuitry is further configured to:
at the upper MAC entity, forward, to the second lower MAC entity, a particular MSDU that is allocated to the second channel and the PN assigned to the particular MSDU.

5. The apparatus according to claim 1, the processing circuitry is further configured to:
at the upper MAC entity, forward a same MAC address to the first and second lower MAC entities for inclusion in MPDUs of the first and second lower MAC entities.

6. The apparatus according to claim 1, wherein:
the PNs are for reordering of decoded MSDUs, and
the SN of the MPDU is for an acknowledgement of decoded MPDUs on the first channel.

7. The apparatus according to claim 1, wherein the aggregated link is configurable for channels in a same frequency band or for channels in multiple frequency bands.

8. The apparatus according to claim 1, wherein the aggregated link is configurable for a particular configuration wherein:
the first channel is configured for usage by the AP for communication with a station (STA) in a first frequency band, and
the second channel is configured for usage by another AP for communication with the STA in a second frequency band.

9. The apparatus according to claim 1, wherein the AP is arranged to operate in accordance with a wireless local area network (WLAN) protocol.

10. The apparatus according to claim 9, the processing circuitry further configured to determine, based on an enhanced distributed channel access (EDCA) traffic class prioritization, a priority of the MPDU based on a queue of MPDUs to be transmitted on the first channel.

11. The apparatus according to claim 1, wherein the processing circuitry includes a baseband processor to encode the control frame, assign the PNs, allocate the MSDUs, and generate the MPDU.

12. The apparatus according to claim 1, wherein the apparatus further includes a transceiver to transmit the MPDU.

13. A non-transitory computer-readable storage medium that stores instructions for execution by one or more processors to perform operations for communication by an access point (AP), the operations to configure the one or more processors to:
encode, for transmission, a control frame to establish an aggregated link for communication on a plurality of channels;
decode medium access control (MAC) protocol data units (MPDUs) received on one or more channels of the plurality;
encode, for transmission, one or more block acknowledgement (BA) frames that include reception information for the MPDUs based on per-channel sequence numbers (SNs) included in the MPDUs;
decode MAC service data units (MSDUs) based on the decoded MPDUs; and
reorder the decoded MSDUs based at least partly on packet numbers (PNs) included in the decoded MPDUs.

14. The non-transitory computer-readable storage medium according to claim 13, wherein:
the one or more channels on which the MPDUs are received from the STA are a first portion of the channels for which the AP is configured to communicate with a station (STA),
the MSDUs are first MSDUs,
the PNs included in the decoded MPDUs are first PNs,
the operations further configure the one or more processors to:
decode second MSDUs received from another AP configured to communicate with the STA on a second portion of the channels;
reorder the first and second MSDUs based on the first PNs and further based on second PNs included in the second MSDUs.

15. The non-transitory computer-readable storage medium according to claim 14, wherein the aggregated link is configurable for a particular configuration wherein:
a first channel used for communication between the AP and the STA is in a first frequency band, and
a second channel used by the other AP for communication with the STA is in a second frequency band.

16. A method of communication at an access point (AP), the method comprising:
assigning packet numbers (PNs) to medium access control (MAC) service data units (MSDUs) to be sent on an aggregated link comprising a plurality of channels, wherein a first portion of the channels are supported by the AP and a second portion of the channels are supported by another AP;
sending a second portion of the MSDUs to the other AP for transmission on the second portion of the channels;
allocating the first portion of the MSDUs to the first portion of the channels in accordance with a load balance of data traffic on the first portion of the channels;
contending for a transmission opportunity (TXOP) to obtain access to at least one particular channel of the first portion of the channels; and
generating, for transmission within the TXOP on the particular channel, a MAC protocol data unit (MPDU) based on one of the MSDUs that is allocated to the particular channel,
wherein the MPDU includes a sequence number (SN) based on a transmission queuing order of the particular channel, and the MPDU further includes the PN assigned to the MSDU on which the MPDU is based.

17. The method according to claim 16, wherein the aggregated link is configurable for a particular configuration wherein:
the first portion of the channels are in a first frequency band, and
the second portion of the channels are in a second frequency band.

18. An apparatus of an access point (AP), the apparatus comprising: memory; and processing circuitry, configured to:
contend for a transmission opportunity (TXOP) to obtain access to a particular link of an aggregated link comprising a plurality of links;
assign packet numbers (PNs) to a sequence of medium access control (MAC) service data units (MSDUs), wherein the PNs assigned to consecutive MSDUs are spaced apart by a predetermined PN spacing, wherein the PN spacing is configurable to a value greater than or equal to one;
allocate the MSDUs to the links of the plurality; and
generate, for transmission on the particular link within the TXOP, a MAC protocol data unit (MPDU) based on one of the MSDUs allocated to the particular link,
wherein the MPDU includes the PN of the MSDU on which the MPDU is based, wherein the MPDU further includes a sequence number (SN) based at least partly on a chronological order of transmission on the particular link.

19. The apparatus according to claim 18, wherein:
the PNs are for reordering of the MSDUs of the sequence, and
the SN is for per-link acknowledgement of MPDUs.

20. The apparatus according to claim 18, wherein the PN spacing is based at least partly on a maximum number of MPDU fragments into which MPDUs are to be fragmented.

21. The apparatus according to claim 20, wherein:
the MSDU on which the MPDU is based is a first MSDU,
the processing circuitry is further configured to generate, for transmission on the particular link, a sequence of MPDU fragments based on a second MSDU allocated to the particular link,
a number of MPDU fragments in the sequence is less than or equal to the maximum number of MPDU fragments,
consecutive MPDU fragments of the sequence include consecutive PNs,
a starting MPDU fragment of the sequence includes the PN of the second MSDU, and
the MPDU fragments further include SNs based at least partly on the chronological order of transmission on the particular link.

22. The apparatus according to claim 19, wherein:
the PN spacing is based at least partly on a maximum number of control frames or management frames that may be sent by the AP between consecutive MSDUs, and
the processing circuitry is further configured to encode a control frame or management frame for transmission between a first MPDU and a second MPDU,
the first MPDU is based on a first MSDU that is assigned a first PN,
the second MPDU is based on a second MSDU that is assigned a second PN, and
the control frame or management frame includes a PN that is between the first and second PNs.

23. The apparatus according to claim 19, wherein:
the links of the aggregated link are between the AP and a station (STA), and
the aggregated link is configurable for links supported in a same frequency band or for links supported in different frequency bands.

24. The apparatus according to claim 19, wherein:
the particular link of the aggregated link is between the AP and a station (STA),
another link of the aggregated link is between the STA and another AP, and
the processing circuitry is further configured to forward, to the other AP, an MSDU that is allocated to the other link.

25. The apparatus according to claim 19, wherein:
the SN included in the MPDU is included in a medium access control (MAC) header of the MPDU, and
the PN included in the MPDU is included in a counter mode cipher block chaining message authentication code (CBC-MAC) protocol (CCMP) header of the MPDU or in a Galois/Counter mode protocol (GCMP) header of the MPDU.

26. An apparatus of a station (STA), the apparatus comprising: memory; and processing circuitry, configured to:
decode medium access control (MAC) protocol data units (MPDUs) received on a plurality of links of an aggregated link, wherein the MPDUs include packet numbers (PNs) based on a sequence of MAC service data units (MSDUs) on which the MPDUs are based, wherein the MPDUs further include sequence numbers (SNs) based on per-link chronological orders of transmission on the links;
encode a block acknowledgement (BA) frame that includes reception information for the received MPDUs, the reception information based on the SNs of the MPDUs;
decode MSDUs based on the decoded MPDUs; and
determine a reordered sequence of MSDUs that includes the decoded MSDUs reordered based on the PNs of the decoded MPDUs.

27. The apparatus according to claim 26, the processing circuitry further configured to:
decode MPDU fragments received on the plurality of links, wherein the MPDU fragments include PNs based on the sequence of MSDUs and further include SNs based on the per-link chronological orders of transmission; and
reassemble the MPDU fragments into decoded MPDUs based at least partly on the PNs of the MPDU fragments.

28. The apparatus according to claim 26, wherein:
the links of the aggregated link are between the STA and one or more access points (APs), and
the aggregated link is configurable for links supported in a same frequency band or for links supported in different frequency bands.
